(19) United States
(12) Patent Application Publication
(10) Pub. No.: US 2006/0173142 A1
(43) Pub. Date: Aug. 3, 2006

(54) Functionalized thermosetting resin systems

(76) Inventors: Hildeberto Nava, Cary, NC (US); Aaron C. Small, Raleigh, NC (US)

Correspondence Address: MYERS BIGEL SIBLEY & SAJOVEC, PO BOX 37428, RALEIGH, NC, 27627, US

(21) Appl. No.: 11/048,173

(22) Filed: Feb. 1, 2005

(51) Int. Cl. C08L 79/00; C08L 51/00; B32B 27/00

(52) U.S. Cl. 525/540

(57) ABSTRACT

The present invention provides a crosslinkable polymer system that can be crosslinked to form a wide variety of polymeric, copolymeric and oligomeric compounds. The crosslinkable system comprises a product Q formed from an aromatic ethylenically unsaturated moiety and a first reactive ethylenically unsaturated moiety, and a second reactive ethylenically unsaturated moiety at least partially reacted with the first reactive ethylenically unsaturated moiety, and a first terminal moiety comprising a covalently bonded nitroxide containing group.

### BACKGROUND OF THE INVENTION

The thermosetting resin market primarily includes unsaturated polyesters, vinyl esters and urethane acrylates. Some disadvantages found in these types of resins are their hydrolytic, chemical, and thermal stabilities. Ester groups and urethane groups, common in unsaturated polyester resin (UPR) systems, are very sensitive towards degradation or cleavage in hydrolytic and many other chemical environments. Unsaturated polyesters which contain certain aromatic repeating units such as those based on terephthalate and/or isophthalate diacids, as well as saturated ring repeating units such as those based on cyclohexane diacids, in combination with diols such as neopentyl glycol and hexane diol, exhibit a certain improved level of hydrolytic and chemical stability. However, highly enhanced hydrolytic stability or chemical stability typically cannot be achieved due to the presence of ester groups. Ester groups tend to have inadequate stability under hydrolytic conditions (neutral, basic, and acidic) and many other chemical environments irrespective of how carefully the chemical structure of the polymer is selected.

An additional inherent problem with unsaturated polyesters is their shrinkage. Shrinkage with thermosetting resin systems can be as high as five percent, depending on unsaturated polyester alkyd reactivity and crosslinking monomer structure and level. Shrinkage usually occurs during the curing process and can affect the dimensional stability by warping the finished parts. It is desirable to reduce the shrinkage and improve the surface appearance of the molded articles. This problem can be alleviated by the addition of low profile additives such as thermoplastics. Often however, phase separation of the mixture arises due to incompatibility of the low profile additive(s) with the unsaturated polyester. Addition of expensive compatibilizers contributes to high price finished material and sometimes even this action is not guaranteed to prevent phase separation.

Another problem associated with the preparation of composites materials is their environmental impact. All thermosetting resins during the curing process are followed by an exotherm evolution from the reaction of the monomers and the unsaturation in the polymers. The exotherm produced heats up the system to a point that it creates emissions into the atmosphere of volatile organic compounds (VOC's) during the curing of the resins. Recent environmental regulations require that the emission of VOC's be reduced to a minimum to reduce toxic materials in the atmosphere. For this reason, in the last few years there has been a large interest on the preparation of liquid resins with high solids content due in part to the lower proportions of VOC's, which significantly reduce air emissions during the application process.

The physical properties of polymers are dictated by their molecular weight and are directly related to the viscosity of the resin. Polymers with higher molecular weight are typically associated with higher glass transition temperature (Tg) and viscosity values. Mechanical properties of polymers, e.g., flexural strength, tensile strength, are also directly related to the molecular weight of the polymers. In general, the higher the molecular weight, the better performance is observed in a polymer. However, high molecular weight polymers have high viscosities in solution and require large amounts of monomer to have a desirable “workable viscosity”. A workable viscosity would be such that the material is easily mixed, rolled or sprayed over a surface without any problems. Therefore, in order to have resins with environmental compliance, it is necessary to have polymers with the appropriate molecular weight that can be dissolved in low amounts of monomers in order to yield low viscosities.

It would be highly desirable to prepare polymers and copolymers with low molecular weight that can have improved properties such an enhanced hydrolytic stability, thermal stability, good mechanical properties, crosslinking ability and low shrinkage. Limited numbers of raw materials and their high prices control the possibilities to improve hydrolytic and thermal stability for most applications where thermosetting systems are utilized. Ester groups by nature have inadequate stability under hydrolysis and independently of how the chemical structure of the polymer is, careful selection has to be done with respect to the repeating units to enhance the properties of the finished material. However, the improvements are limited due to the presence of ester groups. Since ester and urethane segments are not very stable to hydrolysis, the present invention is aimed at preparing polymeric materials that have segments in their repeating units formed by carbon-carbon linkages. These linkages have much greater thermal and hydrolytic stability and can be obtained from a variety of monomers. Monomers include styrene, vinyl toluene, tert-butyl styrene, α-methyl styrene, and other alkyl substituted styrenics. Also included are halogenated styrenics, such as bromostyrenes, chlorostyrenes, dibromostyrenes, dichlorostyrenes, etc. Other vinyl aromatic monomers may also be included.

It would also be highly desirable to prepared polymers that in addition to having good hydrolytic and thermal stability have crosslinkable functional groups. Polymers, copolymer or oligomers containing crosslinkable groups can then undergo crosslinking reactions with other thermosets such as polyesters, vinyl esters and urethane acrylates and with a variety of monomers to form three-dimensional networks. Curing of the thermoset mixtures typically takes place by using radiation, by using a peroxide followed by thermal polymerization, or at room temperature using a peroxide and a promoter package that aids decomposition of the peroxide. It is noted that for the purpose of this invention, the term “cure” or “curing” means the transformation of the resins systems from liquid to gel or solid state. The curing occurs during the crosslinking process of the reactive sites of the resin(s) and the ethylenical unsaturation of the monomers containing the resin(s). Depending on the catalyst system used, curing typically occurs at temperatures from about 5° C. to about 150° C. for a time of 30 seconds to about 48 hours.

There are a large number of patents for molding compositions that describe the preparation of materials with low shrinkage and good physical properties. The patents describe compositions that include unsaturated polyesters, ethylenically unsaturated monomers and thermoplastic polymers used as low profile additives to control shrinkage. The molding compositions are processed at temperatures in the range of 100 to 150° C. Lower temperatures do not provide the desired mechanical properties, good surface profile and low shrinkage. Examples of molding compositions are described in U.S. Pat. Nos. 4,555,534; 4,172,059 and 5,296,544.

The thermoplastic polymers used as low profile additives to control shrinkage are described to have molecular weights in the range of 10,000 to about 250,000. The low profile additives are described as not containing functional groups and some are described as containing acid group functionality. U.S. Pat. Nos. 4,555,534; 4,525,498 and 5,296,545 describe low profile additives having viscosities in the range of 4000 to 16,000 centipoises at 25° C. and dissolved in 50 to 60 percent concentration of an ethylenically unsaturated monomer such as styrene. The viscosities are too high to have appropriate mixing. High viscosities also create difficulties in applications that require hand lay up and spray up. Typical industrial equipment to spray-up liquid resins in composite applications cannot handle such high viscosities.

U.S. Pat. No. 4,822,849, teaches reducing the shrinkage of the resin systems by reducing both the styrene level and unsaturation. Lower shrinkage is achieved without using a low profile additive, however the viscosities of the mixtures are too high and make it difficult to use them in spray-up.

U.S. Pat. No. 5,380,799 describes the preparation of room temperature moldable resin compositions comprising a thermosetting unsaturated polyester resin, a mixture of thermoplastic polymers of vinyl acetate, an accelerator, and a low temperature free radical peroxide initiator. Low shrink properties are obtained; however, using polyvinyl acetate containing thermoplastics as low profile additives have a side effect of too much water absorption which deteriorates the physical properties of the products.

Chen-Chi Ma et al., describe in Polymer Engineering and Science, Vol. 43, page 989(2003) that the curing rate of unsaturated polyester resins with a low profile additive decreases as the molecular weight of the low profile additive increases due to chain entanglements. This becomes more critical for systems that require curing at room temperature. For the purpose of this invention, high molecular weight low profile additives are undesirable because they cause an increase in the viscosity of the mixtures. In addition, spraying ability of the resin is limited, and poor curing compromises final mechanical properties of the finished products.

Hence, there remains a challenge to create thermosetting resin systems that are devoid of ester or urethane chemical linkages, and thus extremely stable to hydrolysis, resistant to a variety of chemical environments, and exhibit low shrinkage. The objective of the present invention is to prepare polymeric, copolymeric or oligomeric materials that have segments in their repeating units formed mainly by carbon-carbon linkages and that exhibit high hydrolytic, chemical, and thermal stability with little or no shrinkage in absence of any external low profile additives. There is a need for resins with low viscosities that can be cured at room temperature, have good curing, and result in good physical properties and low shrinkage.

### SUMMARY OF THE INVENTION

The present invention provides a crosslinkable polymer system comprising a main portion comprising a product Q formed from an aromatic ethylenically unsaturated moiety and a first reactive ethylenically unsaturated moiety wherein product Q provides carbon-carbon linkages in the backbone of the crosslinkable polymer system, and a second reactive ethylenically unsaturated moiety at least partially reacted with the first reactive ethylenically unsaturated moiety of product Q and a first terminal moiety comprising a nitroxide containing group. Optionally, a second terminal moiety such as a peroxide residue may be included.

The product Q provides carbon-carbon linkages as repeating units in the backbone of the polymer, copolymer or oligomer. The ethylenically unsaturated moieties function both as solvents to carry out the polymerization and as reactive moieties to form the polymeric, copolymeric and/or oligomeric resins. The nitroxide containing group forms a covalent bond with the growing polymer chain and thus radical polymerization can be controlled.

The product Q can also be combined with a variety of polymers to form mixtures with a wide variety of properties. Specifically, the product Q can be combined with a thermosetable moiety, a thermoplastic moiety, or a monomer which is crosslinkable with the reactive ethylenically unsaturated moiety of product Q.

### DETAILED DESCRIPTION OF THE PREFERRED EMBODIMENTS

The present invention now is described more fully hereinafter. The present invention may, however, be embodied in many different forms and should not be construed as limited to the embodiments set forth herein; rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. As used herein, the term “and/or” includes any and all combinations of one or more of the associated listed items. All publications, patent applications, patents, and other references mentioned herein are incorporated herein by reference in their entirety.

The present invention relates to preparing low molecular weight materials which are prepared containing carbon-carbon linkages. The low molecular weight intermediates may be polymeric, copolymeric and oligomeric preferably containing ethylenic unsaturation along the backbone. Additionally, the intermediates may have a variety of reactive functional groups that may include but are not limited to epoxy, silyl, siloxane, acetoacetoxy, anhydride, isocyanato, cyano, halogen, tertiary amines, quaternary ammonium or phosphonium salts, or an active hydrogen containing component such as acid (—COOH), hydroxyl (—OH), amino (primary or secondary), amide, phenol, thiol, silanol, —P—OH, —P—H and the like as well as combinations thereof. The functionality contained in the reactive materials is incorporated during the preparation of the low molecular weight materials. The ethylenical unsaturation is incorporated into the low molecular weight materials by a reaction after preparing the intermediates by an additional reaction with a modifier which contains a crosslinkable functional group. The present invention also provides curable compositions with other thermosetting resins or in the presence of thermoplastic resins or their mixtures to form composite materials.

The production of low molecular weight polymers, copolymers and oligomers useful in the present invention are prepared by nitroxide mediated radical polymerization. This is a method to control radical polymerization which employs stable scavenging radicals to reversibly trap growing radicals and thereby eliminate irreversible termination. The nitroxide containing compound(s) used in the present invention is stable at room temperature and also under polymerization conditions. During the polymerization, a stable free radical of the nitroxide compound forms a covalent bond with the growing polymer chain. The growing free radical continuously alternates at the end of the polymer chain and as the reaction progresses, the nitroxide free radical detaches from the growing chain to allow the insertion of a monomer unit(s). Examples of nitroxide containing compounds used in this invention include 2,2,6,6-tetramethyl-1-piperidinyloxy (hereinafter referred as TEMPO), 4-hydroxy-TEMPO, 4-amino-TEMPO, and 4-oxo-TEMPO. The nitroxide containing compounds may be used alone or as a mixture or two or more. The polymerization using stable free radicals of the nitroxide containing compounds allows for monomers with a variety of functionality. Examples can be found in U.S. Pat. Nos. 6,117,961; 6,509,428; 6,576,730; 5,610,249; and U.S. 2003/0208021 A1.

One skilled in the art will recognize that there are many ways to prepare the polymers, copolymers and oligomers of the present invention using reactive ethylenically unsaturated moieties. For the purpose of this invention, the term “reactive functional groups” means any ethylenically containing moiety, epoxy, silyl, siloxane, acetoacetoxy, anhydride, isocyanato, cyano, halogen, tertiary amines, quaternary ammonium or phosphonium salts, or an active hydrogen containing component such as acid (—COOH), hydroxyl (—OH), amino (primary or secondary), amide, phenol, thiol, silanol, —P—OH, —P—H and the like as well as combinations thereof. The polymers, copolymers and oligomers may be linear, block copolymers, graft, comb-like, star-like, hyperbranch and can include two or more different monomers.

For example, the polymer, copolymer, or oligomer may be prepared by anionic polymerization which controls the molecular weight by maintaining the appropriate monomer to initiator ratios. For example, U.S. Pat. Nos. 4,158,736, 4,208,313, 4,356,288 and 6,197,892, propose the preparation of functionalized polymers with low molecular weight. Alkoxide anions are used as initiators.

The polymer, copolymer or oligomer useful in the present invention may also be prepared by cationic polymerization of oligomers from vinyl type monomers. For example, European Patent Application EP 202,965 and Japanese Patent No. 02180907 A2 disclose oligomers prepared using a perfluorosulfonic acid resin catalyst.

The production of low molecular weight polymers, copolymers and oligomers may also be possible by free radical polymerization using a transition metal chelate complexes such as for example dioxime complexes of cobalt (II) or cobalt(II) porphyrin complexes. Suitable methods for preparing the low molecular weight intermediates are disclosed for example in U.S. Pat. Nos. 6,602,960, 6,716,915, 4,526,945 and 4,680,354.

Methods for preparing low molecular weight styrene polymers, copolymers and oligomers useful in the present invention containing hydroxyl groups or silane crosslinkers are described, for example in U.S. Pat. Nos. 6,294,607; 5,382,642 and 5,444,141. Styrene and allyl alcohol are the main components in combination with a variety of acrylate monomers. The reaction is performed using radical initiators.

The radical polymerization of vinyl type monomers in a variety of solvents is another approach to obtain low molecular weight polymers, copolymers and oligomers. Examples are disclosed in U.S. Pat. Nos. 4,276,212, 4,510,284 and 4,501,868. The solvents preferably used are within a boiling point of 90° C. to 180° C. Typically, the solvent is charged to the reactor, the reaction temperature is set and then gradually the monomer and initiator are added to the reactor.

Other methods to polymerize vinyl type monomers by radical initiators can be accomplished using solvents and high pressure. Examples are disclosed in U.S. Pat. Nos. 6,433,098, 6,388,026, 3,979,352; and European Patent Applications EP 0197460, WO 0037506 and WO 0105843. Temperatures used can be in the range of 120° C. to 350° C., pressure ranging from 3 MPa to 35 MPa, and residence times from 0.1 seconds to 30 minutes.

Thermally initiated polymerization of monomers is also possible to obtain low molecular weight materials. In this case polymerization is initiated by heating as opposed to adding radical initiators. For example, U.S. Pat. No. 4,414,370 describes a thermally initiated polymerization process for preparing low molecular weight polymers in a continuous reactor, at temperatures from 235° C. to 310° C., with a resident time of at least 2 minutes. European patent EP 687690 describes the use of a temperature range of 250° C. to 500° C. with resident times ranging from 0.1 seconds to 5 minutes. Low molecular weight polymers initiated by thermal polymerization are also described in, for example, U.S. Pat. Nos. 4,414,370, 4,529,787, 4,546,160 and 5,770,667.

WO 98/01478 describes a method called RAFT (Reversible Addition-Fragmentation Transfer) in which thio-esters are used as transfer agents. Molecular weight is control by the monomer to initiator ratios in combination with the thio-esters.

The production of low molecular weight polymers, copolymers and oligomers useful in the present invention may also be possible by free radical polymerization, in which a “living” polymer contains a radical transferable atom or group to enable control of the composition and architecture. The method, referred as Atom Transfer Radical Polymerization (ATRP) proceeds by the metal catalyzed polymerization which includes a halogenated hydrocarbon initiator, a transition metal catalyst and a ligand that can form a coordination compound with the metallic catalyst. Examples can be found in U.S. Pat. Nos. 5,807,937, 5,789,487, 5,763,548, 6,391,996 and 6,284,850.

The rough surface and imperfections of composites is attributed in part to the shrinkage in volume of the polymer and monomer relative to the reinforcing material as the resin system polymerizes. It is also desirable to control shrinkage of the polymers and oligomers containing reactive functional groups as well as their blends with other thermosetting or thermoplastic resins.

Such polymers, copolymers or oligomers can form mixtures and undergo crosslinking reactions with other thermosetting moieties, other thermoplastic moieties or monomer(s) to form composite materials.

The method of the present invention is suitable in the preparation of polymers, copolymer and oligomers that may be linear, block copolymers, graft, comb like, star like, hyper branch and include two or more different monomers. It is thus possible to control the molecular weight of the polymeric intermediates of the present invention by selecting an appropriate nitroxide mediated radical polymerization initiator, selecting the polymerization temperature, and selecting the amount and type of monomers added at one time. The nitroxide initiator may be added all at once or in portions as the polymerization proceeds. The monomers may also be added all in one portion or in a continuous addition process. The resulting intermediates of the present invention have low molecular weights and reactive functional groups capable of undergoing further chemical reactions to form finished products.

To facilitate understanding of the present invention, a general scheme is summarized below. The scheme is for the illustrations purposes only, not intended to limit the scope of the invention. It is also understood that some of the steps may be carried out simultaneously or sequentially.

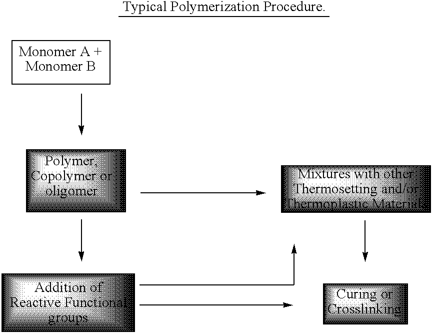

In the present invention, a polymer, copolymer or an oligomer is prepared from a mixture which comprises at least two monomers, Monomer A and Monomer B. From this mixture, at least one monomer functions as a solvent to carry out the polymerization although not intended to limit this scope, a solvent and a variety of other materials such as initiator, peroxides or inhibitor may be added. Monomer A is preferentially an ethylenically unsaturated aromatic material and monomer B is a different ethylenically unsaturated monomer and may contain reactive functional groups. The polymerization temperatures will depend on the type of initiator and desired polymerization rates. Preferably, the polymerization may be performed at a temperature between 10° C. to 200° C., and most preferably from 50° C. to 130° C.

The monomer A and monomer B may be combined in various ways to carry the polymerization. For example, the monomers may be combined prior to the start of the polymerization reaction to form the polymerization reaction mixtures. Alternatively, a portion of monomer A or B may be added to the reactor to initiate the polymerization and monomer B or a mixture of monomers A and B could be gradually fed during the polymerization into monomer A initially charged. A third ethylenically unsaturated monomer, monomer C, may be added to the reaction mixture to provide other properties to the resulting polymeric intermediates. Properties may include modification of the glass transition temperature (T_{g}) or mechanical properties such as tensile and flexural strength or elongation.

The initiator can also be added in various ways. For example, the initiator can be added to the mixture of monomers before the polymerization is started. Alternatively, all or a portion of the initiator can be co-fed as a separate feed stream as part of the monomers, and/or alone or any combination of these methods. The selection of the initiator will depend on such factors as the initiator's solubility in the monomers and the functional groups that the initiators may contain. The amount of initiator use depends on the targeted molecular weight of the polymer, copolymer or oligomer. Preferably, the initiator may be added in an amount from 0.001 weight percent to 10 weight percent and most preferably from 0.3 weight percent to about 5 percent based on the total amount of monomers in the mixture.

The preferred method of combining the monomers and initiator will depend on the desired ultimate properties of the polymer, copolymer or reactive oligomer. For example, the distribution of the monomers along the backbone of the polymers can be affected by the concentration of the mixture of monomers during the polymerization. If the polymerization is performed by a batch process, the concentration of monomers will be high, while a semi-continuous will keep the second monomer concentration low during the reaction. Therefore, by using an appropriate monomer addition it is possible to control the distribution of segments and final configuration of the polymer, copolymer or oligomer.

All the reactions involved in the process discussed herein, it is understood that they can be carried out individually in a continuous mode, a continuous stirred tank reactor mode, or a combination thereof. The various stages of the process may be carried out in the same reactor or different reactors. It is preferred to carry out the polymerization reaction in a batch process. The reactor geometry and/or resident time may be adjusted to provide different mixing rates for controlling the product yield, product composition and/or product properties.

In the case where the polymerization is induced by heating, the heating temperature is usually from 10° C. to 200° C. and a pressure from 0.10 MPa to 30 MPa, and preferably from 50° C. to 130° C. and a pressure from 0.10 MPa to 10 MPa. The optimum temperature will vary depending on the nitroxide initiator, the peroxide catalyst used and the desired polymerization rates. Polymerization is normally conducted at temperatures known to be appropriate for the nitroxide initiator selected. The determination of suitable temperatures is well within the skill of one in the art and who could do so without undue experimentation.

Another possible way to prepare the polymer, copolymer or oligomer intermediates is by the thermal initiated polymerization of styrene-based polymers. The elevated temperature and sufficient reaction times results in the formation of radical species by autopolymerization of the styrene-based monomers. Significant formation of these autopolymerization radicals occurs during the heating process and these radicals are captured by adding nitroxide radical initiators to give “in situ” unimolecular initiators. It is possible to conduct free-radical polymerizations in the absence of added peroxide initiating systems relying only on the added nitroxide radical initiators to mediate the polymerization. The “in situ” generation of unimolecular initiators by the reaction of nitroxide initiators with the radicals generated by the autopolymerization of styrene may permit well-defined vinyl polymers to be prepared with controlled molecular weights and low polydispersities.

The preparation of polymers, copolymers or oligomers may also be accomplished by using electromagnetic radiation such as UV radiation (UV), visible light radiation (VIS), γ-irradiation, X-ray irradiation (X-ray), electron beam irradiation (E-Beam), electrochemical generation of free radicals, photochemical generation of free radicals and combinations thereof. For E-Beam and/or electromagnetic irradiations such as UV is irradiation in the polymerization process, the composition may further comprise one or more photoinitiators as and additive(s) which function as free radical initiator(s), cationic initiator(s), or anionic initiator(s). A general reference for photo free-radical generations and photoinitiators can be found in “Photgeneration of Reactive Species for UV Curing” by C. Roffey, John Wiley & Sons, New York, N.Y. (1997). The intensity of the electromagnetic radiation will vary depending upon the types of the radical initiators and the monomers used. Usually the wavelength of such radiation rays is preferably at least 180 nm to 450 nm.

In the case that polymerization is induced by irradiation with light rays, it is possible to conduct the polymerization by putting the monomer(s) in a reactor or container which transmits a light ray and irradiating the monomer with light rays from the exterior of the container. The temperature at that time may be room temperature or higher or lower than room temperature. From the view point of the operation efficiency, the temperature is preferably room temperature. The polymerization time varies depending on the distance from the light source, the type of container used, and the type of monomers, nitroxide initiators and free radical initiators, and can be appropriately adjusted by one skilled in the art depending upon various polymerization conditions.

While it is generally preferred to recover the product from each individual reaction of the process prior to conducting the next reaction, the present invention also will work with minimum or no recovery or no purification. For example it is not required to separate the polymers prior to reacting with a modifier to produce the curable compositions, or to carry out the post-generation of functional groups. Typical recovery or purification methods include, but are not necessarily limited to distillation, extraction, filtration, centrifugation, sedimentation, solvent removal, residual monomer removal, catalyst removal, precipitation, recrystalization, chromatography, and combination thereof.

Preferably, the process of the present invention does not require the elimination of the residual monomer after the polymerization. The residual monomer at the end of the polymerization may range from 0.25 weight percent to about 70 weight percent. The level of monomer will be adjusted accordingly to comply with environmental regulations. In those instances where the monomer concentration is too low, additional monomer will be added to adjust the concentration. The monomers that are post added may be monofunctional or polyfunctional of a mixture of both. The rations will depend on the desired final properties of the crosslinked materials.

The reaction between the functional groups of the polymer, copolymer or oligomer and the reactive moiety of a modifier may be carried out under a second condition which depends on the functional group, the reactive moiety, the solvent (if present) and the physical and chemical properties of the polymer, copolymer or oligomer and the modifier. The reaction between a functional group and a reactive moiety may be conveniently carried out in air if there are no substantial side reactions or by-product formations. Sometimes air or oxygen needs to be present in order to allow certain inhibitors such as hydroquinone to be used effectively. Optionally, a different non-reactive atmosphere may be used, particularly if air may interfere with the reaction and/or cause any of the components to decompose or deteriorate. Examples of gases for providing such non-reactive atmosphere include, but are not necessarily limited to nitrogen, argon, helium or mixtures thereof. Gases like carbon dioxide also may be used alone or in conjunction with the non-reacting atmosphere described above if such gases do not interfere with the reaction and/or cause any of the components to decompose or deteriorate.

For example, ethylenical unsaturation is incorporated into the polymer, copolymer or oligomer produced by a reaction after preparing the intermediates by an additional reaction with a monomer which contains a crosslinkable functional group that in some cases may be similar to monomer B. The incorporation of ethylenically unsaturated groups onto the polymers, copolymer or oligomers containing functional groups may be accomplished by a variety of ways that may include, but are not necessarily limited to hydrolysis, esterification, trans-esterification, etherification, urethane formation, amide formation, and the ring opening of an epoxy moiety. The reaction between the functional group(s) of the polymer, copolymer or oligomer and the reactive moiety of a modifier is carried out under different reaction conditions which depend on the functional group, the reactive moiety, the solvent (if present), and the expected final properties of the cured material. The reaction temperature to modify the functional groups may be in the range of 0° C. to 250° C. with a reaction time between 1 second to 120 hours. Optionally, pressure may be applied but it is necessary only in those occasions where the monomer has a high vapor pressure.

Various additives can be introduced to the polymerization mixture of Monomer A and Monomer B. For example, antioxidants, solvents, polymerization inhibitors, chain transfer agents, polymerization accelerators and UV stabilizers may be added to the polymerization mixture. Various additives may be introduced prior to crosslinking, and include fiber reinforcements, fillers, thickening agents, flow agents, lubricants, air release agents, wetting agents, UV stabilizers, compatibilizers, shrink reducing agents, waxes, and release agents.

The present invention also provides curable compositions with other thermosetting resins or in the presence of thermoplastic resins or their mixtures to form composite materials. The thermosetting resins, thermoplastic resins or other monomers added may also contribute to the modification of the final desired properties of the finished products.

Thus the present invention provides the following embodiments:
1. A crosslinkable polymer system comprising a main portion comprising a product Q formed from an aromatic ethylenically unsaturated moiety and a first reactive ethylenically unsaturated moiety wherein product Q provides carbon-carbon linkages in the backbone of the crosslinkable polymer system and a second reactive ethylenically unsaturated moiety at least partially reacted with the first reactive ethylenically unsaturated moiety of product Q; and a first terminal moiety comprising a covalently bonded nitroxide free radical group.
2. A crosslinkable polymer system comprising a main portion comprising a product Q formed from an aromatic ethylenically unsaturated moiety and a reactive ethylenically unsaturated moiety, said product Q providing carbon-carbon linkages in the backbone of the crosslinkable system, and a thermosetable moiety, a thermoplastic moiety or a monomer wherein the product Q and the thermosetable moiety, thermoplastic moiety or monomer is crosslinkable with the reactive moiety of product Q; and a first terminal moiety comprising a covalently bonded nitroxide free radical group.
3. A crosslinkable polymer system comprising a product Q formed from an aromatic ethylenically unsaturated moiety and a first reactive ethylenically unsaturated moiety wherein product Q provides carbon-carbon linkages in the backbone of the crosslinkable polymer system, a second reactive ethylenically unsaturated moiety at least partially reacted with the first reactive ethylenically unsaturated moiety of product Q, and a thermosetable moiety, a thermoplastic moiety or a monomer wherein the thermosetable moiety, thermoplastic moiety or monomer is crosslinkable with the first or second reactive ethylenically unsaturated moiety or both; and a first terminal moiety comprising a covalently bonded nitroxide free radical group.

One skilled in the art will recognize that polymers, copolymers and oligomers may be prepared containing “reactive functional groups” in a variety of combinations. The examples below are to illustrate although not intended to limit this scope of the multiple possibilities in the formation of the intermediates:
1. The functional group(s) contained in the polymer backbone can be selected from an epoxy group. When an epoxy group is selected, this moiety may be reacted with, for example, acrylic acid, methacrylic acid, crotonic acid, maleic or fumaric acid esters, itaconic acid, long or short chain monocarboxylic acid, aryl and aryl substituted monocarboxylic compounds, phenolic and the like and mixtures thereof to incorporate vinyl or non-vinyl functionality into the polymer backbone.
2. The functional group(s) contained in the polymer backbone can be selected from a carboxylic acid group. When a carboxylic acid group is selected, this moiety may be reacted with, for example, glycidyl acrylate, gycidyl methacrylate, glycidyl crotonate and 1-vinyl-4-cyclohexene epoxide, siloxy(meth)acrylates, hydroxyalkyl (meth)acrylates, primary or secondary alkyl amine(meth)acrylates and mixtures thereof to incorporate vinyl functionality into the backbone.
3. The functional group(s) contained in the polymer backbone can be selected from a hydroxyl group. When a hydroxyl group is selected, this moiety may be reacted with, for example, isocyanato ethyl methacrylate, toluene diisocyanate intermediates containing one equivalent of hydroxyethyl acrylate or methacrylate, acryloyl or methacryloyl chloride, or methacrylate, acryloyl or methacryloyl bromide, other alkyl acetyl chloride or bromide, acrylic acid, methacrylic acid, crotonic acid, maleic or fumaric acid esters, itaconic acid, long or short chain monocarboxylic acid, siloxy(meth)acrylates, aryl and aryl substituted monocarboxylic compounds and mixtures thereof to incorporate vinyl functionality into the backbone.
4. The functional group(s) contained in the polymer backbone can be selected from a primary or secondary amino group. When an amine group is selected, this moiety may be reacted with, for example, isocyanato ethyl methacrylate, toluene diisocyanate intermediates containing one equivalent of hydroxyethyl acrylate or methacrylate, acrylic acid, methacrylic acid, crotonic acid, maleic or fumaric acid esters, itaconic acid, long or short chain monocarboxylic acid, siloxy(meth)acrylates, aryl and aryl substituted monocarboxylic compounds and mixtures thereof to incorporate vinyl functionality into the backbone.
5. The functional group(s) contained in the polymer backbone can be selected from an anhydride group. When an anhydride group is selected, this moiety may be reacted with, for example, hydroxyethyl acrylate, hydroxyethyl methacrylate, hydroxypropyl acrylate, hydroxypropyl methacrylate, allyl alcohol, hydroxyethyl crotonate, hydroxypropyl crotonate, hydroxybutyl acrylate, hydroxybutyl methacrylate, hydroxybutyl crotonate, primary or secondary alkyl amine (meth)acrylates and mixtures thereof to incorporate vinyl functionality into the backbone.
6. The functional group(s) contained in the polymer backbone can be selected from an isocyanate group. When an isocyanate group is selected, this moiety may be reacted with, for example, hydroxyethyl acrylate, hydroxyethyl methacrylate, hydroxypropyl acrylate, hydroxypropyl methacrylate, other polyfunctional (meth)acrylates containing one hydroxyl group, allyl alcohol, hydroxyethyl crotonate, hydroxypropyl crotonate, hydroxybutyl acrylate, hydroxybutyl methacrylate, hydroxybutyl crotonate, amino ethyl acrylate, aminoethyl methacrylate, acrylamide and mixtures thereof to incorporate vinyl functionality into the backbone.
7. The functional group(s) contained in the polymer backbone can be selected from a halogen group. When an halogen group is selected, this moiety may be reacted with, for example, hydroxyethyl acrylate, hydroxyethyl methacrylate, hydroxypropyl acrylate, hydroxypropyl methacrylate, allyl alcohol, hydroxyethyl crotonate, hydroxypropyl crotonate, hydroxybutyl acrylate, hydroxybutyl methacrylate, hydroxybutyl crotonate, 4-hydroxy styrene, 3-hydroxystyrene and their alkoxy substituted styrene derivatives and mixtures thereof to incorporate vinyl functionality into the backbone. The reaction may be performed for example under phase transfer catalysis (PTC). Typical phase transfer catalysts include but are not limited to, quaternary ammonium, phosphonium, arsonium, antimonium, tertiary sulfonium salts and crown ethers.

Other functionalities such as silyl, siloxane, acetoacetoxy, cyano, tertiary amines, quaternary ammonium or phosphonium salts or an active hydrogen containing component such as phenol, thiol, silanol, —P—OH, —P—H and the like as well as combinations thereof may also be used without limiting the scope of this invention. The functional groups may be completely reacted or only a portion of them. In some cases, the polymers, copolymers or oligomers may be used after their preparation without further modification.

The polymers, copolymers or oligomers of the present invention preferably have the following formula: 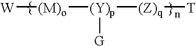
wherein:
W—is a moiety of a radical polymerization catalyst, a residue of an ethylenically unsaturated monomer prereacted with a nitroxide initiator, or a residue of an alkyl or aryl compound prereacted with a nitroxide monomer.
M—is a moiety, that is free of reactive functional groups, of at least one ethylenically unsaturated radically polymerizable monomer.
Y—is a moiety, that has a reactive functional group, of at least one ethylenically unsaturated monomer.
G—is a vinyl unsaturated monomer that is capable of reacting with the reactive functional groups of Y. G can be a straight or branched alkyl, aryl, aryloxy of from 1 to 40 carbon atoms, aliphatic or aromatic polymeric intermediates with molecular weights of up to 50,000 containing functional groups such as epoxy, silyl, siloxane, acetoacetoxy, anhydride, isocyanato, cyano, halogen, tertiary amines, quaternary ammonium or phosphonium salts or an active hydrogen containing component such as acid (—COOH), hydroxyl (—OH), amino (primary or secondary), amide, phenol, thiol, silanol, —P—OH, —P—H and the like as well as combinations thereof.
Z—is a moiety, that is free of reactive functional groups, of at least one ethylenically unsaturated radical polymerizable monomer containing aliphatic and/or aromatic groups and may contain a straight or branched alkyl, aryl, aryloxy of from 1 to 40 carbon atoms, aliphatic or aromatic polymeric intermediates with molecular weights of up to 50,000.
T—represents a covalently bonded nitroxide free radical group.
o—is a number from 1 to 90
p—is a number from 1 to 50
q—is a number from 0 to 30
o, p, q, and n are each independently selected for each structure such as the polymer, copolymer or oligomer has a weight average molecular weight (Mw) of at least 400 to 80,000 g/mol, preferably in the range of 600 to 50,000 g/mol and especially preferably from 1000 to 40,000 g/mol.

The polymer, copolymers and oligomers of the present invention have the ability of continuing polymerization to form crosslink networks with other thermosetable monomers or vinyl unsaturated monomers. The crosslinking process takes place during the reaction of the thermosetting systems using any polymerization procedure that may include any radical polymerizable process. During this process, the nitroxide moiety is able to undergo reactions with either the unsaturated moieties from another thermosetting resin available in the resin system or by reactions with other vinyl unsaturated monomers. This reaction process allows all components in the resin mixtures to form networks with enhanced properties. In addition, polymer chains will be linked to the network so that they will not diffuse off by exposing the network to high temperatures or due to time exposed to different environmental conditions. Additionally, the nitroxide moiety and/or the radical initiator residue may contain a functionality that may be derived from epoxy, silyl, siloxane, acetoacetoxy, anhydride, isocyanato, cyano, halogen, tertiary amines, quaternary ammonium or phosphonium salts or an active hydrogen containing component such as acid (—COOH), hydroxyl (—OH), amino (primary or secondary), amide, phenol, thiol, silanol, —P—OH, —P—H and the like as well as combinations thereof. The functional group can further be reacted with other reactive moieties and/or participate in the crosslinking process during the curing of the resins systems.

### Reactive Ethylenically Unsaturated Moieties

1) Alkenes:

In the present invention, any radically polymerizable alkene can serve as a monomer for polymerization. However, co-monomers that correspond to the following formula are especially suitable for polymerization in accordance with the invention: 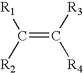
where R₁ and R₂ are independently selected from the group consisting of H, halogen, CN, straight or branched alkyl of from 1 to 20 carbon atoms, preferably 1 to 6 and specially preferably 1 to 4 carbon atoms, which can be substituted with 1 to (2n+1) halogen atoms where n is the number of carbon atoms of the alkyl group (for example CF₃), α, β-unsubstituted straight or branched alkenyl or alkynyl groups with 2 to 10 carbon atoms, preferably 2 to 6 and specially preferably 2 to 4 carbon atoms which can be substituted with 1 to (2n−1) halogen atoms where n is the number of carbon atoms of the alkyl group, a, α-unsaturated straight or branched of 2 to 6 carbon atoms (preferably vinyl) substituted (preferably at the α-position) with a halogen (preferably chlorine), C₃-C₈ cycloalkyl, heterocyclyl, C(═Y)R₅, C(═Y)NR₆R₇, YC(═Y)R₅, SOR₅, SO₂R₅, OSO₂R₅, NR₈SO₂R₅, PR₅², P(═Y)R₅², YPR₅², YP(═Y)R₅², NR₈², which can be quaternized with an additional R₈, aryl, or heterocyclyl group, where Y may be NR₈, S or O, preferable O; R₅ is alkyl of from 1 to 20 carbon atoms, an alkylthio group with 1 to 20 carbon atoms, OR₁₅ (OR₁₅ is hydrogen or an alkyl metal), alkoxy of from 1 to 20 carbon atoms, aryloxy or heterocyclyloxy; R₆ and R₇ are independently H or alkyl of from 1 to 20 carbon atoms, or R₆ and R₇ may be joined together to form an alkylene group of from 2 to 7 carbon atoms, preferably 2 to 5 carbon atoms, where they form a 3- to 8-member ring, preferably 3 to 6 member ring, and R₈ is H, straight or branched C₁-C₂₀ alkyl or aryl; and R₃ and R₄ are independently selected from the group consisting of H, halogen (preferably chlorine or fluorine), C₁-C₆ alkyl or COOR₉, where R₉ is H, an alkyl metal, or a C₁-C₄₀ alkyl group; or R₁ and R₃ can together form a group of the formula (CH₂)ₙ; which can be substituted with 1 to 2n halogen atoms or a group of the formula C(═O)—Y—C(═O), where n is from 2 to 6, preferably 3 to 4, and Y is defined as before; and where at least two of R₁, R₂, R₃ and R₄ are H or methyl group.

Furthermore in the present application, “aryl” refers to phenyl, naphthyl, phenanthryl, anthracenyl, phenalenyl, triphenylenyl, fluoranthrenyl, pyrenyl, pentacenyl, chrycenyl, naphthacenyl, hexaphenyl, picenyl and perynelenyl (preferably phenyl and naphthyl), in which each hydrogen atom may be replaced with alkyl of from 1 to 20 carbon atoms (preferably from 1 to 6 carbon atoms and more preferably methyl) alkyl of from 1 to 20 carbon atoms (preferably from 1 to 6 carbon atoms and more preferably methyl) in which each of the hydrogen atoms is independently replaced by a halide (preferably a fluoride or a chloride), alkenyl of from 2 to 20 carbon atoms, alkynyl of from 1 to 20 carbon atoms, alkoxy from 1 to 6 carbon atoms, alkylthio of from 1 to 6 carbon atoms, C₃-C₈ cycloalkyl, phenyl, halogen, NH₂, C₁-C₆-alkylamino, C₁-C₆ dialkylamino, and phenyl which may be substituted with the from 1 to 5 halogen atoms and/or C₁-C₄ alkyl groups. (This definition of “aryl” also applies to the aryl groups in “aryloxy” and “aralkyl”). Thus phenyl may be substituted from 1 to 5 times and naphthyl may be substituted from 1 to 7 times (preferably, any aryl group, if substituted, is substituted from 1 to 3 times) with one of the above substituents. More preferably, “aryl” refers to phenyl, naphthyl, phenyl substituted from 1 to 5 times with fluorine or chlorine, and phenyl substituted from 1 to 3 times with a substituent selected from the group selected from the group consisting of alkyl of from 1 to 6 carbon atoms, alkoxy of from 1 to 4 carbon atoms and phenyl. Most preferably, “aryl” refers to phenyl, tolyl and methoxyphenyl.

In the context of the present invention, “heterocyclyl” refers to pyrydyl furyl, pyrrolyl, furyl, pyrrolyl, thienyl, imidazolyl, pyrazolyl, pyrazinyl, pyridiminyl, pyridazinyl, pyranyl, indonyl, isoindonyl, indazolyl, benzofuryl, isobenzofuryl, benzothienyl, isobenzothienyl, chromenyl, xanthenyl, purinyl, pteridinyl, quinolyl, isoquinolyl, phthalazinyl, quinazolinyl, quinoxalinyl, naphthyridinyl, phenoxathiinyl, carbazolyl, cinnolinyl, phenanthridinyl, acridinyl, 1,10-phenanthrolinyl, phenazinyl, phenoxazinyl, phenothiazinyl, oxazolyl, thiazolyl, isoxaloyl, and hydrogenated forms thereof known to those in the art. Preferred hetrerocyclyl groups include imidazolyl, pyrazolyl, pyrazinyl, pyridyl, furyl, pyrrolyl, thienyl, pyrimidinyl, pyridazinyl, pyranyl, and indolyl.

Ethylenically unsaturated monomers that may be included as a diluent, reactant, co-reactant or may be post added once the polymerization of the desired polymer, copolymer and/or oligomer was completed, and may include those such as, for example, styrene and styrene derivatives such as α-methyl styrene, p-methyl styrene, 3-methyl styrene, divinyl benzene, divinyl toluene, ethyl styrene, vinyl toluene, tert-butyl styrene, monochloro styrenes, dichloro styrenes, vinyl benzyl chloride, fluorostyrenes, tribromostyrenes, tetrabromostyrenes, alkoxystyrenes (e.g., paramethoxy styrene), 2-hyroxyethyl styrene, 4-ethyl styrene, 4-ethoxystyrene, 3,4-dimethylstyrene, 11-vinylnaphthalene, vinylphenanthrene, vinyl carbazole, and vinyl pirrolidone. Other monomers which may be used include, 2-vinyl pyridine, 6-vinyl pyridine, 2-vinyl pyrrole, 2-vinyl pyrrole, 5-vinyl pyrrole, 2-vinyl oxazole, 5-vinyl oxazole, 2-vinyl thiazole, 5-vinyl thiazole, 2-vinyl imidazole, 5-vinyl imidazole, 3-vinyl pyrazole, 5-vinyl pyrazole, 3-vinyl pyridazine, 6-vinyl pyridazine, 3-vinyl isoxozole, 3-vinyl isothiazole, 2-vinyl pyrimidine, 4-vinyl pyrimidine, 6-vinyl pyrimidine, any vinyl pyrazine. Classes of other vinyl monomers also include, but are not limited to, (meth)acrylates, vinyl aromatic monomers, vinyl halides and vinyl esters of carboxylic acids. As is used herein and in the claims, by “(meth)acrylate” and the like terms is meant both (meth)acrylates and acrylates. Examples include but are not limited to oxyranyl (meth)acrylates like 2,3-epoxybutyl(meth)acrylate, 3,4-epoxybutyl(meth)acrylate, 10,11 epoxyundecyl(meth)acrylate, 2,3-epoxycyclohexyl(meth)acrylate, glycidyl(meth)acrylate, hydroxyalkyl(meth)acrylates like 3-hydroxypropyl(meth)acryl ate, 2,5-dimethyl-1,6-hexanediol (meth)acryl ate, 1,10-decanediol (meth)acryl ate, aminoalkyl(meth)acrylates like N-(3-dimethylaminopentyl(meth)acryl ate, 3-dibutylaminohexadecyl(meth)acrylate; nitriles of (meth)acrylic acid and other nitrogen containing (meth)acrylates like N-((meth)acryloyloxyethyl)diisobutylketimine, N-((meth)acryloylethoxyethyl)dihexadecylketimine, (meth)acryloylamidoacetonitrile, 2-(meth)acryloxyethylmethylcyanamide, cyanoethyl(meth)acrylate, aryl(meth)acrylates like benzyl(meth)acrylate or phenyl(meth)acrylate, where the acryl residue in each case can be unsubstituted or substituted up to four times; carbonyl-containing (meth)acrylates like 2-carboxyethyl(meth)acrylate, carboxymethyl(meth)acrylate, oxazolidinylethyl (meth)acrylate, N-((meth)acryloyloxy) formamide, acetonyl(meth)acrylate, N-(meth)acryloylmorpholine, N-(meth)acryloyl-2-pyrrolidinone, N-(2-(meth)acryloxyoxyethyl)-2-pyrrolidinone, N-(3-(meth)acryloyloxypropyl)-2-pyrrolidinone, N-(2-(meth)acryloyloxypentadecenyl)-2-pyrrolidinone, N-(3-(meth)acryloyloxyheptadecenyl)-2-pyrrolidinone; (meth)acrylates of ether alcohols like tetrahydrofurfuryl(meth)acrylate, vinyloxyethoxyethyl(meth)acrylate, methoxyethoxyethyl (meth)acrylate, 1-butoxypropyl(meth)acrylate, 1-methyl-(2-vinyloxy)ethyl(meth)acrylate, cyclohexyloxymethyl(meth)acrylate, methoxymethoxyethyl(meth)acrylate, bezyloxymethyl (meth)acrylate, furfuryl(meth)acrylate, 2-butoxyethyl(meth)acrylate, 2-ethoxyethoxymethyl (meth)acrylate, 2-ethoxyethyl(meth)acrylate, allyloxymethyl(meth)acrylate, 1-ethoxybutyl (meth)acrylate, ethoxymethyl(meth)acrylate; (meth)acrylates of halogenated alcohols, like 2,3-dibromopropyl(meth)acrylate, 4-bromophenyl(meth)acrylate 1,3-dichloro-2-propyl (meth)acrylate, 2-bromoethyl(meth)acrylate, 2-iodoethyl(meth)acrylate, chloromethyl (meth)acrylate, 2-isocyanatoethyl methacrylate, vinyl isocyanate, 2-acetoacetoxyethyl methacrylate; phosphorus-, boron, and/or silicon-containing (meth)acrylates like 2-(dimethylphosphato)propyl(meth)acrylate, 2-(ethylphosphito)propyl(meth)acrylate, dimethylphosphinoethyl(meth)acrylate, dimethylphosphinomethyl(meth)acrylate, dimethylphosphonoethyl(meth)acrylate, dimethyl(meth)acryloyl phosphonate, dipropyl(meth)acryloyl phosphate, 2-(dibutylphosphono)ethyl methacrylate, 2,3-butelene(meth)acryloylethyl borate, methyldiethoxy(meth)acryloylethoxysilane, vinyltrimethoxysilane, vinyltriethoxysilane, vinyltrichlorosilane, allyltrichlorosilane, allyltrimethoxysilane, allyltriethoxysilane, γ-methacryloxypropylmethoxysilane, diethylphosphatoethyl(meth)acrylate; sulfur-containing (meth)acrylates like ethylsulfinylethyl(meth)acrylate, 4-thiocyanatobutyl(meth)acrylate, ethylsulfonylethyl (meth)acrylate, thiocyanathomethyl(meth)acrylate, methylsulfonylmethyl(meth)acrylate, bis((meth)acryloyloxyethyl)sulfide; vinyl halides such as vinyl chloride, vinyl fluoride, vinylidene chloride and vinylidene fluoride; vinyl esters like vinyl acetate, vinyl butyrate, vinyl 3,4-dimethoxybenzoate, vinyl benzoate and isoprenyl esters; crotonic acid, itaconic acid or anhydride, maleic acid and maleic acid derivatives such as mono and diesters of maleic acid, maleic anhydride, methyl maleic anhydride, methylmaleimide; fumaric and fumaric acid derivatives such as mono and diesters of fumaric acid.

2) Polyfunctional Monomers.

Suitable polyfunctional acrylates may be used in the resin composition of this invention, including those described, for example, in U.S. Pat. No. 5,925,409 to Nava, the disclosure of which is incorporated by reference herein in its entirety. Such compounds include, but are not limited to, ethylene glycol (EG) dimethacrylate, butanediol dimethacrylate, and the like. The polyfunctional acrylate which may be used in the present invention can be represented by the general formula: 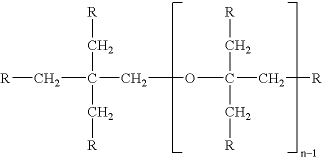
wherein at least four of the represented R's present are (meth)acryloxy groups, with the remainder of the R's being an organic group except (meth)acryloxy groups, and n is an integer from 1 to 5. Examples of polyfunctional acrylates include ethoxylated trimethyolpropane triacrylate, trimethyolpropane tri(meth)acrylate, trimethyolpropane triacrylate, trimethylolmethane tetra(meth)acrylate, pentaerythritol tetra(meth)acrylate, dipentaerythritol tetra(meth)acrylate, dipentaerythritol penta(meth)acrylate, and dipentaerythritol hexa(meth)acrylate; heterocyclic (meth)acrylates like 2-(1-imidazolyl)ethyl (meth)acrylate, 2-(4-morpholyl)ethyl(meth)acrylate and 1-(2-(meth)acryloyloxyethyl)-2-pyrrolidinone.
3) Other Unsaturated Monomers.

Suitable polyfunctional “olefins” may be used in the resin composition of this invention. As used herein and in the claims, by “olefin” and the like terms is meant unsaturated aliphatic hydrocarbons having one or more double bonds, obtained by cracking petroleum fractions. Specific examples of olefins may include, but are not limited to, propylene, 1-butene, 1,3-butadiene, isobutylene and di-isobutylene.

As used herein and in the claims, by “(meth)allylic monomer(s)” is meant monomers containing substituted and/or unsubstituted allylic functionality, i.e., one or more radicals represented by the following general formula:
H₂C═C(Q)-CH₂—
wherein Q is a hydrogen, halogen or a C₁ to C₄ alkyl group. Most commonly, Q is a hydrogen or a methyl group, but are not limited to; (meth)allyl alcohol; (meth)allyl ethers, such as methyl(meth)allyl ether, (meth)allyl esters of carboxylic acids, such as (meth)allyl acetate, (meth)allyl benzoate, (meth)allyl n-butyrate, (meth)allyl esters of VERSATIC acid, and the like.

The components can be used individually or as mixtures. However, a requirement is that at least two different monomers are polymerized.

These components can be added to a reaction mixture at the same time or sequentially in order to obtain copolymers in accordance with the invention. Statistical copolymers, gradient copolymers, graft copolymers, random copolymers and block copolymers result, in each case according to the type of addition.

A large number of mixtures, which all contain monomers that are to be polymerized, can be used to obtain the desired compositions of the polymers, copolymers and oligomers. Also, continues or batch wise mixtures of the monomer mixtures is conceivable, where their compositions are in general kept constant over the period of the addition in order to ensure a statistical distribution of the individual structural units in the polymer or copolymer.

Besides statistical copolymers, gradient and block copolymers can be obtained by the method of this invention by varying the composition of monomers, thus the relative concentration of the two monomers to each other during the polymerization.

Random copolymers can be also obtained by adding mixtures of monomers during the polymerization. The monomers in the reaction mixture may function as the solvent medium and reactant. Additional monomers may be post added once the desired molecular weight and conversion in the polymerization mixture was reached.

### Nitroxide Polymerization Initiators

Initiators used in the polymerization of the present invention include nitroxide containing compounds such as stable hindered nitroxide compounds having the structural formula: 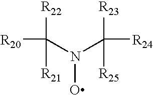
where R₂₀, R₂₁, and R₂₅ are identical or different and represent a hydrogen atom, a linear, branch or cyclic alkyl radical having a number of carbon atoms ranging from 1 to 30, an aryl radical, or an aralkyl radical having a number of carbon atoms ranging from 1 to 30, R₂₂ and R₂₃ are independently selected from the group consisting of: C₁-C₂₀ alkyl, C₂-C₁₈ alkenyl, C₂-C₁₈ alkynyl, C₃-C₁₂ cycloalkyl, C₃-C₁₂ heterocycloalkyl, and C₆-C₂₄ aryl, all of which are optionally substituted by NO₂, halogen, amino, hydroxy, cyano, carboxy, ketone, C₁-C₄ alkoxy, C₁-C₄ alkylthio, C₁-C₄ alkylamino; or, R₂₂ and R₂₃ can be connected to one another to form a ring, a C₃-C₁₂ cycloalkyl radical, a (C₄-C₁₂ alkanol)yl radical or a C₂-C₁₃-heterocycloalkyl radical containing oxygen, phosphorus, sulfur or nitrogen atoms; or R₂₂ and R₂₃ together can form a residue of a polycyclic ring system or a polycyclic heterocycloliphatic ring system containing oxygen, phosphorus, sulfur or nitrogen atoms. Optionally at least one of the radicals R₂₂ and R₂₃ contains a functionality that may derived from epoxy, silyl, siloxane, acetoacetoxy, cyano, halogen, tertiary amines, an active hydrogen containing component such as acid (—COOH), hydroxyl (—OH), amino (primary or secondary), amide, phenol, thiol, silanol, —P—OH, —P—H and the like as well as combinations thereof. The functional group can further be reacted with other reactive moieties and/or participate in the crosslinking process during the curing of the resins systems. R₂₃ and R₂₅ can be connected to one another so that to form a ring which includes the carbon atom carrying the said R₂₃ and R₂₅ radicals, the ring having including the carbon carrying the R₂₃ and R₂₅ radicals, ranging from 3 to 8 carbon atoms; R₂₄ is independently selected from the group consisting of halogen, cyano, COOR₂₀, —S—COR₂₀, —OCOR₂₀, amido, —S—C₆H₅, carbonyl, alkenyl, and alkyl of 1 to 15 carbon atoms, or may be part of a cyclic structure which may be fused with it another saturated or aromatic ring; —P(U)R₁₈R₁₉, where R₁₈ and R₁₉ are identical or different, represent a linear or branch alkyl having a number of carbon atoms ranging from 1 to 20 or a cycloalkyl, aryl, alkoxyl, aryloxyl, aralkyloxyl, perfluoroalkyl, aralkyl, dialkyl or diarylamino, alkylarylamino or thioalkyl radical, or R₁₈ and R₁₉ are connected to one another so as to form a ring which includes the phosphorus atom, the heterocycle having a number of carbon atoms ranging from 2 to 4 and being able in addition to comprise of one or more oxygen, sulfur or nitrogen atoms, U represents an oxygen, sulfur or selenium atom, and U is equal to zero or 1.

Other examples of nitroxide initiators containing functional groups are described in U.S. Pat. Nos. 6,569,967; 6,657,043 and US2004/0077873, and also in “Handbook of Radical Polymerization” by K Matyjaszewski and T. P. Davis, Wiley Interscience, 2002.

For the purpose of this invention, nitroxide initiators containing phosphorous or alkyl groups can be used in this invention to prepare polymers, copolymers and oligomers. Examples are found in Neil R. Cameron and Alistar J. Reid in Macromolecules Vol. 35, page 9890 (2002), Michael K. Georges et al., in Macromolecules, Vol. 37, page 1297 (2004) and D. Bertin et al., in Journal of Polymer Science: Part A: Polymer Chemistry, Vol. 42, page 3504 (2004).

Examples of nitroxide free radical initiators include but are not limited to 2,2,6,6-tetramethyl-1-piperidinyloxy (TEMPO), 4-hydroxy-2,2,6,6-tetramethyl-1-piperidinyloxy(4-hydroxy TEMPO), 3-carbamoyl-2,2,5,5-tetramethylpyrrolidin-1-yloxy, 3-carbamoyl-2,2,5,5-tetramethyl-3-pyrrolin-1-yloxy, di-t-butyl nitroxide and 2,6,-di-t-butyl-a-(3,5-di-t-butyl-4-oxo-2,5-cyclohexadien-1-ylidene)-p-tolyloxy.

Accordingly one of the several classes of nitroxides that can be employed in the practice of the present invention can be presented by the following structural formula: 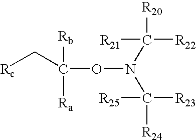
Where R₂₀, R₂₁, R₂₂, R₂₃, R₂₄ and R₂₅ are as defined above. Rₐ, R_{b} and R_{c} may be represented by H, halogen, CN, straight or branched alkyl of from 1 to 40 carbon atoms, a COOR₉, where R₉ is H, an alkyl metal, or a C₁-C₄₀ alkyl group; an epoxy moiety that can be present from 1 to 4 groups. R_{b} and R_{c} are independently selected from the group consisting of halogen, cyano, COOR₂₀, —S—COR₂₀, —OCOR₂₀, amido, —S—C₆H₅, carbonyl, alkenyl, or alkyl of 1 to 15 carbon atoms, or may be part of a cyclic structure which may be fused with it another saturated or aromatic ring. Rₐ is a straight or branched alkyl of from 1 to 40 carbon atoms containing reactive functional groups such as epoxy, silyl, siloxane, acetoacetoxy, anhydride, isocyanato, cyano, halogen, tertiary amines, quaternary ammonium or phosphonium salts or an active hydrogen containing component such as acid (—COOH), hydroxyl (—OH), amino (primary or secondary), amide, phenol, thiol, silanol, —P—OH, —P—H and the like as well as combinations thereof.

Other examples of nitroxide initiators containing reactive functional groups are found for example in U.S. Pat. No. 6,566,468, incorporated here in its entirety as a reference. Other examples of TEMPO nitroxide containing functional groups are described in U.S. Pat. No. 6,686,424, also European Patent Application EP0945474 and WO97/36894.

A variety of methods can also be used to make telechelic, branched and start like polymers, copolymers and oligomers of this invention. Without intending any limitation, examples of these methods can be found in U.S. Pat. Nos. 4,81,429; 5,723,511; 6,114,499 and 6,258,911.

Optionally, if the rate of polymerization is slower than desired, a variety of compounds may be added to speed up the polymer formation. Compounds to accelerate the reaction are used in combination with the nitroxide initiator and the radical polymerization catalyst and can include organic phosphorus compounds containing trivalent or pentavalent phosphorus, organic compounds containing carboxylic acid or sulfonic acid groups or Lewis acids.

Nitroxides also function as initiators in the presence of peroxide radicals and can also be used as such in the present invention. Peroxide may be excluded from the polymerization in those cases that the nitroxide has been pre-reacted with a compound that can allow the transfer of the nitroxide to another molecule such as a vinyl group.

The initiator is in general used in a concentration in the range of 0.005 to 5 weight percent based on monomers, preferably in the range of 0.5 to 3 weight percent based on monomers and especially preferably in the range of 0.7 to 1.5 weight percent based on monomers, without any limitations intended by this. The molecular weight of the polymer results from the ratio of the initiator to monomer, if all the monomer is converted.

### Polymerization Initiators

The preparation of polymers, copolymers or oligomers of the present inventions also includes an initiator such as an organic peroxide compound. The peroxide and the nitroxide initiator(s) react onto the vinyl unsaturation. Depending on the choice of peroxide and nitroxide initiator, an appropriate temperature is applied to promote the polymerization. The molecular weight of the polymer then increases and will depend on the monomer to initiator ratios. Exemplary organic peroxides are selected from a list that includes, but is not limited to the following:

diacyl peroxides such as benzoyl peroxides; ketone peroxides such as mixtures of peroxides and hydroperoxides; methyl isobutyl ketone; 2,4-pentanedione peroxide; methyl ethyl ketone peroxide/perester blend;

peroxydicarbonates such as di(n-propyl)peroxydicarbonate, di(sec-butyl)peroxydicarbonate; di(2-ethylhexyl) peroxydicarbonate; bis(4-t-butyl-cyclohexyl) peroxydicarbonate; diisopropyl peroxydicarbonate; diacetyl peroxydicarbonate;

peroxyesters such as alpha-cumyl peroxydecanoate; alpha-cumyl peroxyneoheptanoate; t-amyl peroxybenzoate; t-amyl peroxy-2-ethylhexanoate; t-butylperoxyneodecanoate; t-butylperoxypivalate; 1,5-dimethyl 2,5-di(2-ethylhexanoyl peroxy)hexane; t-butylperoxy-2-ethylhexanoate; t-butylperoxy isobutyrate; t-butylperoxymaleic acid; t-butyl-isopropyl carbonate2,5-dimethyl-2,5-di(benzoylperoxy)hexane; t-butylperoxy-acetate; t-butylperoxybenzoate; di-t-butylperoxy acetate; t-butyl peroxybenzoate; di-t-butyl diperoxyphthalate; mixtures of the peroxy esters and peroxyketal; t-amylperoxyneodecanoate; t-amylperoxypivalate; t-amylperoxy(2-ethylhexanoate); t-amylperoxyacetate; t-amylperoxy(2-ethylhexanoate); t-amylperoxyacetate; t-amylperoxybenzoate; t-butylperoxy-2-methyl benzoate;

dialkylperoxides such as dicumyl peroxide; 2,5-dimethyl-2,5-di(t-butylperoxy)hexane; 2,5-dimethyl-2,5-di(t-butylperoxy)dexyne-3; t-butyl cumyl peroxide; α,α-bis(t-butylperoxy)diisopropylbenzene; di-t-butyl peroxide;

hydroperoxides such as 2,5-dihydro-peroxy-2,5-dimethylhexane; cumene hydroperoxide; t-butylhydroperoxide;

peroxyketals such as 1,1-di(t-butylperoxy) 3,3,5-trimethylcyclohexane; 1,1-di(t-butylperoxy)cyclohexane; ethyl-3,3-di(t-butylperoxy)butyrate; n-butyl 4,4-bis(t-butylperoxy)pivalate; cyclic peroxyketal; 1,1-di(t-amylperoxy)cyclohexane; 2,2-di-t-amylperoxy propane;

azo type initiators such as 2,2′-azobis(2,4-dimethylvaleronitrile); 2,2′azobis(isobutyronitrile); 2,2′azobis(methylbutyronitrile); 1,1′-azobis(cyanocyclohexane);

Alternatively a radiation curing type initiator can be used. Exemplary radiation curing type initiators include but are not limited to, an aliphatic or aromatic diketone and a reducing agent (e.g., benzyl and dimethylbenzil amines); vicinal polyketaldonyl compounds (e.g., diacetyl benzyl ketal); α-carbonyl alcohols (e.g., benzoin); acyloin ethers (e.g., benzoin methyl ether); polynuclear quininos (e.g., 9,10-anthraquinone) and benzophenone; acylphosphine oxides and diacylphosphine oxides (e.g. terephthaloyl-bis-diphenyl phosphine oxide, p-toluyl-diphenyl phosphine oxide, bis(2,4,6-trimethylbenzoyl)-phenylphosphineoxide); cationic initiators such as aryldiazonium salts, arylsulfonium and aryliodonium salts, ferrocenium salts, phenylphosphonium benzophenone salts, aryl tert-butyl peresters and titanocens and mixtures thereof. Preferably, the amount of radiation curing type initiator ranges from about 0.005 to 5 percent based on the weight on the resin composition. Suitable commercial radiation curing type initiators include those available from Ciba-Geigy Corporation sold under the trade names Irgacure 500, Irgacure 369, Irgacure 1700, Darocure 4265, and Irgacure 819. It should be appreciated that other commercial radiation curing type initiators may be used for the purpose of the invention.

The preferred catalysts are diacyl peroxides such as benzoyl peroxides; peroxyesters such as t-butyl peroxybenzoate; t-amyl peroxybenzoate; t-butyl peroxy-2-ethylhexanoate; t-amyl peroxy-2-ethylhexanoate; dialkyl peroxides such as 2,5-dimethyl-2,5-di-(t-butylperoxy)hexane and di-t-butyl peroxide; ketone peroxides such as mixtures of peroxides and hydroperoxides; methyl isobutyl ketone; 2,4-pentanedione peroxide; methyl ethyl ketone peroxide/perester blend. Mixtures of any of the above may be used. The agent is preferably employed in an amount from about 0.01 to 5.0 weight percent based on the weight of the monomers, more preferably from about 0.5 to 2.5 percent by weight, and most preferably from about 1 to 1.25 percent by weight.

### Polymerizations Solvents

The polymerization is carried in a solvent. The term solvent is to be broadly understood here. The solvents include the same ethylenically unsaturated monomers used during the polymerization allowing their reaction conversion in general in the range of 10 to 99 percent, preferably from 30 to 90 percent and especially preferably from 50 to 80 percent, without this intending to imply any limitation. Preferred monomers used as solvents and reactants include styrene monomers, methyl methacrylate and butyl acrylate, hydroxyethyl (meth)acrylate, hydroxypropyl(meth)acrylate, glycidyl(meth)acrylate, polyfunctional acrylates and may be use in a range of 0.05 to 99 percent by weight as a mixture.

Other solvents that may be used are nonpolar solvents. Among these are aromatic hydrocarbon solvents like toluene, benzene and xylene, and saturated hydrocarbon solvents such as cyclohexane, heptane, octane, nonane, decane, dodecane, which can also occur in branched form. These solvents can be used individually and as a mixture. The nonpolar solvents may be used in the ranges from 0 to 50% by weight, preferably 0 to 20% by weight and especially preferably 0 to 5% by weight, without this intending to imply any limitation. The skill in the art will find valuable advice for choosing these and other solvents in U.S. Pat. No. 6,391,996 B1.

The polymers prepared in this way generally have a molecular weight in the range of 400 to 80,000 g/mol, preferably in the range of 600 to 50,000 g/mol, and more preferably from 1,000 to 40,000 g/mol. These values refer to the weight average molecular weight of the polydisperse polymers in the composition.

### Compounds for Increasing Rate of Polymerization

When the polymerization is conducted according to the present process, optionally in order to increase the rate of polymerization there can be added at least one compound selected from the group consisting of phosphorus compounds, aluminum compounds and boron compounds.

The phosphorus compounds include organic phosphorus compounds containing trivalent or pentavalent phosphorus. Examples thereof are phosphines such as trimethyl phosphine, triethyl phosphine, tri-n-propylphosphine, triisopropylphosphine, tri-n-butylphosphine, triisobutylphosphine, tri-sec-butylphosphine, tri-t-butylphosphine, triphenylphosphine, diphenylphosphine, dimethyl(phenyl)phosphine, methyldiphenylphosphine, tricyclohexylphosphine, dicyclohexylphosphine, tri-n-hexylphosphine, tri-n-hexylphosphine, tri-n-octylphosphine, tri-o-tolylphosphine, tri-m-tolylphosphine, tri-p-tolylphosphine, dicyclo(ethyl)phosphine, dicyclo(phenyl)phosphine, chlorodiphenylphosphine, tetraphenyldiphosphine, bis(diphenylphosphino)methane, 1,2-bis(diphenylphosphino)ethane, 1,3-bis(diphenylphosphino)propane, 1,4-bis(diphenylphosphino)butane and the like, phosphine oxides such as tri-n-butylphosphine oxide, triphenyl phosphine oxide, tri-n-octyl phosphine oxide and the like; phosphorus acid esters such as trimethylphosphate, dimethylphosphate, tritheyl phosphate, diethylphosphate, triisopropyl phosphate, tri-n-butyl phosphate, triphenyl phosphate, diphenyl isodecyl phosphate, phenyl diisooctyl phosphate, triisooctyl phosphate, di(nonylphenyl)dinonylphenyl phosphate, tris(nonylphenyl) phosphate, tris(2,4-di-t-butylphenyl)phosphate, cyclic neopentane tetrayl bis(2,4-di-t-butylphenyl) phosphate, 2,2-methylene bis(4,6-di-t-butylphenyloctyl) phosphate, 4,4,-butylene bis(3-methyl-6-t-butylphenyl-di-tridecyl) phosphate, distearyl pentaerythritol diphosphite, diisodecyl pentaerythritol diphosphite and the like; phosphorus amides such as hexamethylphosphorus triamide, hexaethylphosphorus triamide and the like; phosphoric acid esters such as trimethyl phosphate, triethyl phosphate, triethyl phosphate, tri-n-butyl phosphate, triphenyl phosphate and the like.

Aluminum compounds that can be used in the present invention include, for example, aluminum trimethoxide, aluminum triethoxide, aluminum triisopropoxide, aluminum tri-n-butoxide, aluminum tri-sec-butoxide, aluminum tri-t-butoxide and the like.

Boron compounds which can be used in the present invention include, for example, trimethoxyborane, triethoxyborane, triisipropylborane, triphenoxyborane and the like.

### Polymerization Inhibitors

Polymerization inhibitors may also be included in the polymerization mixture such as phenol, 2,6-di-tert-butyl-4-methyl phenol, hydroquinone (HQ), tolu-hydroquinone (THQ), bisphenol “A” (BPA), naphthoquinone (NQ), p-benzoquinone (p-BQ), butylated hydroxy toluene (BHT), Hydroquinone monomethyl ether (HQMME), 4-ethoxyphenol, 4-propoxyphenol, and propyl isomers thereof, monotertiary butyl hydroquinone (MTBHQ), ditertiary Butyl hydroquinone (DTBHQ), tertiary butyl catechol (TBC), 1,2-dihydroxybenzene, 2,5-dichlorohydroquinone, 2-acetylhydroquinone, 1,4-dimercaptobenzene, 4-aminophenol, 2,3,5-trimethylhydroquinone, 2-aminophenol, 2-N,N,-dimethylaminophenol, catechol, 2,3-dihrydroxyacetrophenone, pyrogallol, 2-methylthiophenol. Other substituted and un-substituted phenols and mixtures of the above may also be used.

Other inhibitors that may be used include oxime compounds of the following formula: 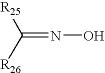
where R₂₅ and R₂₆ are the same or different and are hydrogen, alkyl, aryl, aralkyl, alkyl hydroxyaryl or aryl hydroxyalkyl groups having three to about 20 carbon atoms. The skill in the art will find valuable advice for choosing these components in international patent WO 98/14416.

The nitroxide initiators described in this invention can also be used as inhibitors. Additional amounts of nitroxide can be added after the polymerization has been completed as required to inhibit or delay any premature gelation of the reactive intermediates.

### Chain Transfer Agents

Chain transfer agents may also be included during the preparation of polymers, copolymers and oligomers of the present invention. The chain transfer reaction in a radical polymerization involves a process in which the polymer radical reacts with another molecule (monomer, polymers, catalyst, solvent, modifier, etc.) forming a dead polymer and a new radical. By using chain transfer agents it is also possible to control the molecular weight of the copolymers. Polymers can be designed with an appropriate molecular weight to provide specific properties that can yield products suitable for a variety of applications. Numerous examples are known in the literature of chain transfer agents that may be useful in the preparation of polymers and copolymers. Examples include but are not limited to acetone, water, oxygen, chloroform, methyl iodide, benzene, halogenated benzenes, alkylated benzenes, toluene, xylene, acetophenone, 2-butanone, methanol, propanol, butyl alcohol, sec-butyl alcohol, ethylhexyl alcohol, butanediol, carbon tetrachloride, carbon tetrabromide, iodoform, chloroform, glycerol, cumene, cyclohexane, crotonaldehyde, aniline, dimethyl aniline, dimethyl toluidine, tripropyl amine, diethyl zinc, anisole, butyl amine, phenols, naphthols, butyraldehyde, isobutyraldehyde, dioxane, dibutyl phosphine, benzyl sulfide, benzyl disulfide, p-anisoyl disulfide, butanethiol, 1-dodecanethiol, mercapto ethanol, sulfur, dodecyl mercapthane, 1-hexanethiol, lauryl disulfide, mesityl disulfide, 1-nathalene thiol, 1-naphtahloyl disulfide, other thioethers and thioesters. Other chain transfer agents may be included as for example those described in Polymer Handbook 3^{rd} edition, J. Brandrup and E. H. Immergut, John Wiley & Sons.

The materials in accordance with the invention can be used individually or as a mixture, where the term mixture is to be understood broadly. It includes both mixtures of different polymers, copolymers and oligomers of this invention as well as mixtures of polymers and copolymers that comprise but is not limited to polymerization reactions prepared by condensation, addition polymerization, anionic polymerization, cationic polymerization, metal catalyzed polymerization, ring opening polymerization, thermal polymerization, and radical polymerization, such polymers include: saturated polyester resins (e.g., resins employed in hot melt adhesives, low profile agents and powder coatings), unsaturated polyesters (e.g., resins used in forming molded articles), aliphatic and aromatic polyethers, vinyl ester resins (e.g., resins used in filament winding and open and closed molding), polyurethanes, styrenic resins, acrylic resins, polypropylene, polyethylene, ethylene and propylene oxide polymers and copolymers, butadiene resins, and mixtures of any of the above.

### Resins from the Preparation of Mixtures

1) Unsaturated Polyesters.

In another embodiment, polymers, copolymer or oligomers containing reactive functional groups of the present invention can form mixtures and undergo crosslinking reactions with other thermosetting resins or in the presence of thermoplastic resins or their mixtures to form composite materials. For the purpose of the invention, unsaturated polyester resins, saturated polyester resins and vinyl ester resins are preferably employed. An unsaturated polyester resin may be formed from conventional methods. Typically, the resin is formed from the reaction between a polyfunctional organic acid or anhydride and a polyhydric alcohol under conditions known in the art. The polyfunctional organic acid or anhydride which may be employed are any of the numerous and known compounds. Suitable polyfunctional acids or anhydrides thereof include, but are not limited to, maleic acid and anhydride, fumaric acid, citraconic acid, itaconic acid, glutaconic acid, phthalic acid and anhydride, isophthalic acid, terephthalic acid, tetrahydrophthalic anhydride, cyclohexane dicarboxylic acid, succinic anhydride, adipic acid, sebacic acid, azelaic acid, malonic acid, alkenyl succinic acids such as n-dodecenyl succinic acid, dodecylsuccinic acid, octadecenyl succinic acid, and anhydrides thereof. Lower alkyl esters of any of the above may also be employed. Mixtures of any of the above are suitable, without limitation intended by this. Additionally, polybasic acids or anhydrides thereof having not less than three carboxylic acid groups may be employed. Such compounds include 1,2,4-benzenetricarboxylic acid, 1,3,5-benzene tricarboxylic acid, 1,2,4-cyclohexane tricarboxylic acid, 2,5,7-naphthalene tricarboxylic acid, 1,2,4-naphthalene tricarboxylic acid, 1,3,4-butane tricarboxylic acid, 1,2,5-hexane tricarboxylic acid, 1,3-dicarboxyl-2-methyl-2-carboxymethylpropane, tetra(carboxymethyl)methane, 1,2,7,8-octane tetracarboxylic acid, citric acid, and mixtures thereof.

Suitable polyhydric alcohols which may be used in forming the unsaturated polyester resins include, but are not limited to, ethylene glycol, diethylene glycol, propylene glycol, dipropylene glycol, 1,3-butanediol, 1.4-butanediol, 1,3-hexanediol, neopentyl glycol, 2-methyl-1,3-pentanediol, 1,3-butylene glycol, 1,6-hexanediol, hydrogenated bisphenol “A”, cyclohexane dimethanol, 1,4-cyclohexanol, ethylene oxide adducts of bisphenols, propylene oxide adducts of bisphenols, sorbitol, 1,2,3,6-hexatetrol, 1,4-sorbitan, pentaerythritol, dipentaerythritol, tripentaerythritol, sucrose, 1,2,4-butanetriol, 1,2,5-pentanetriol, glycerol, 2-methyl-propanetriol, 2-methyl-1,2,4-butanetriol, trimethylol ethane, trimethylol propane, and 1,3,5-trihydroxyethyl benzene. Mixtures of any of the above alcohols may be used.

DCPD resins used in the composition of the invention are known to those skilled in the art. These resins are typically DCPD polyester resins and derivatives which may be made according to various accepted procedures. As an example, these resins may be made by reacting DCPD, ethylenically unsaturated dicarboxylic acids, and compounds having two groups wherein each contains a reactive hydrogen atom that is reactive with carboxylic acid groups. DCPD resins made from DCPD, maleic anhydride, maleic acid, fumaric acid, orthophthalic acid, phthalic anhydride, isophthalic acid, terephthalic acid, adipic acid, water, and a glycol such as, but not limited to, ethylene glycol, propylene glycol, diethylene glycol, neopentyl glycol, dipropylene glycol, and poly-tetramethylene glycol, are particularly preferred for the purposes of the invention. The DCPD resin may also include nadic acid ester segments that may be prepared in-situ from the reaction of pentadiene and maleic anhydride or added in its anhydride form during the preparation of the polyester. Examples on the preparation of DCPD unsaturated polyester resins can be found in U.S. Pat. Nos. 3,883,612 and 3,986,922.

The DCPD resin may be used in various amounts in the laminating resin composition of the invention. Preferably, the laminating resin composition comprises from about 10 to about 80 weight percent of DCPD resin, and more preferably from about 20 to about 40 weight percent. Preferably, the DCPD resin has a number average molecular weight ranging from about 450 to about 1500, and more preferably from about 500 to about 1000. Additionally, the DCPD resin preferably has an ethylenically unsaturated monomer content of below 35 percent at an application viscosity of 200 to 800 cps.

2) Vinyl Esters.

The vinyl ester resins employed in the invention include the reaction product of an unsaturated monocarboxylic acid or anhydride with an epoxy resin. Exemplary acids and anhydrides include (meth)acrylic acid or anhydride, α-phenylacrylic acid, α-chloroacrylic acid, crotonic acid, mono-methyl and mono-ethyl esters of maleic acid or fumaric acid, vinyl acetic acid, sorbic acid, cinnamic acid, and the like, along with mixtures thereof. Epoxy resins which may be employed are known and include virtually any reaction product of a polyfunctional halohydrin, such as epichlorohydrin, with a phenol or polyhydric phenol. Suitable phenols or polyhydric phenols include, for example, resorcinol, tetraphenol ethane, and various bisphenols such as Bisphenol “A”, 4,4′-dihydroxydiphenyl sulfone, 4,4′-dihydrohy biphenyl, 4,4′-dihydroxydiphenyl methane, 2,2′-dihydoxydiphenyloxide, and the like. Novolac epoxy resins may also be used. Mixtures of any of the above may be used. Additionally, the vinyl ester resins may have pendant carboxyl groups formed from the reaction of esters and anhydrides and the hydroxyl groups of the vinyl ester backbone.

Other components in the resin may include epoxy acrylate oligomers known to those who are skilled in the art. As an example, the term “epoxy acrylates oligomer” may be defined for the purposes of the invention as a reaction product of acrylic acid and/or methacrylic acid with an epoxy resin. Examples of processes involving the making of epoxy acrylates can be found in U.S. Pat. No. 3,179,623, the disclosure of which is incorporated herein by reference in its entirety. Epoxy resins that may be employed are known and include virtually any reaction product of a polyfunctional halohydrin, such as, but not limited to, epichlorohydrin, with a phenol or polyhydric phenol. Examples of phenols or polyhydric phenols include, but are not limited to, resorcinol, tetraphenol ethane, and various bisphenols such as Bisphenol-A, 4,4′-dihydroxy biphenyl, 4,4′-dihydroxydiphenylmethane, 2,2′-dihydroxydiphenyloxide, phenol or cresol formaldehyde condensates and the like. Mixtures of any of the above can be used. The preferred epoxy resins employed in forming the epoxy acrylates are those derived from bisphenol A, bisphenol F, especially preferred are their liquid condensates with epichlorohydrin having a molecular weight preferably in the range of from about 300 to about 800. The preferred epoxy acrylates that are employed of the general formula: 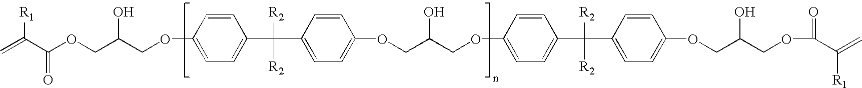
where R₁ and R₂ is H or CH₃ and n ranges from 0 to 1, more preferably from 0 to 0.3.

Other examples of epoxy acrylate oligomers that may be used include comparatively low viscosity epoxy acrylates. As an example, these materials can be obtained by reaction of epichlorohydrin with the diglycidyl ether of an aliphatic diol or polyol.

3) Polyurethane Acrylates.

Polyacrylates are also useful in the present invention for the preparation of the molding compositions. A urethane poly(acrylate) characterized by the following empirical formula may used as part of the mixtures: 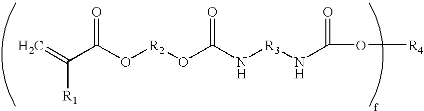
wherein R₁ is hydrogen or methyl; R₂ is a linear or branched divalent alkylene or oxyalkylene radical having from 2 to 5 carbon atoms; R₃ is a divalent radical remaining after reaction of a substituted or unsubstituted diisocyanate; R₄ is the hydroxyl free residue of an organic polyhydric alcohol which contained hydroxyl groups bonded to different atoms; and f has an average value of from 2 to 4. The compounds are typically the reaction products of polyols in which the hydroxyl groups are first reacted with a diisocyanate using one equivalent of diisocyanate per hydroxyl group, and the free isocyanate groups are the reacted with a hydroxyalkyl ester of acrylic or methacrylic acid.

The polyhydric alcohol suitable for preparing the urethane poly(acrylate) typically contains at least two carbon atoms and may contain from 2 to 4, inclusive, hydroxyl groups. Polyols based on the polycaprolactone ester of a polyhydric alcohol such as described in, for example U.S. Pat. No. 3,169,945 is included. Unsaturated polyols may also be used such as those described in U.S. Pat. Nos. 3,929,929 and 4,182,830.

Diisocyanates suitable for preparing the urethane poly(acrylate) are well known in the art and include aromatic, aliphatic, and cycloaliphatic diisocyanates. Such isocyanates may be extended with small amounts of glycols to lower their melting point and provide a liquid isocyanate. The hydroxyalkyl esters suitable for final reaction with the polyisocyanate formed from the polyol and diisocyanate are exemplified by hydroxylacrylate, hydroxypropyl acrylate, hydroxyethyl methacrylate, and hydroxypropyl methacrylate. Any acrylate or methacrylate ester or amide containing an isocyanate reactive group may be used herein, however.

Urethane poly(acrylates) such as the above are described in for example, U.S. Pat. Nos. 3,700,643; 4,131,602; 4,213,837; 3,772,404 and 4,777,209.

A urethane poly(acrylate) characterized by the following empirical formula: 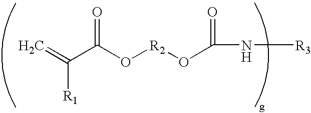
where R₁ is hydrogen or methyl; R₂ is a linear or branched alkylene or oxyalkylene radical having from 2 to about 6 carbon atoms; R₃ is the polyvalent residue remaining after the reaction of a substituted or unsubstituted polyisocyanate; and g has an average value of from about 2 to 4. These compounds are typically the reaction products of a polyisocyanate with a hydroxyalkyl ester per isocyanate group.

Polyisocyanates suitable for preparing the urethane poly(acrylates) are well known in the art and include aromatic, aliphatic and cycloaliphatic polyisocyanates. Some diisocyanates may be extended with small amounts of glycol to lower their melting point and provide a liquid isocyanate.

Urethanes poly(acrylates) such as the above are described in, for example U.S. Pat. No. 3,297,745 and British Patent No. 1,159,552.

A half-ester or half-amide characterized by the following formula: 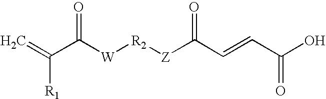
wherein R₁ is hydrogen or methyl. R₂ is an aliphatic or aromatic radical containing from 2 to about 20 carbon atoms, optionally containing —O— or 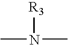
W and Z are independently —O— or 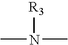
And R₃ is hydrogen or low alkyl. Such compounds are typically the half-ester or half-amide product formed by the reaction of a hydroxyl, amino, or alkylamino containing ester or amide derivatives of acrylic or methacrylic acid with maleic anhydride, maleic acid, or fumaric acid. These are described in, for example, U.S. Pat. Nos. 3,150,118 and 3,367,992.
4) Isocyanurate Acrylates.

An unsaturated isocyanurate characterized by the following empirical formula: 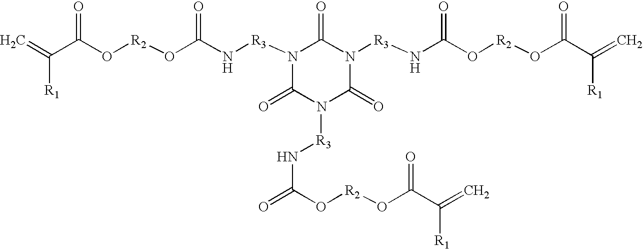
wherein R₁ is a hydrogen or methyl, R₂ is a linear or branched alkylene or oxyalkylene radical having from 2 to 6 carbon atoms, and R₃ is a divalent radical remaining after reaction of a substituted or unsubstituted diisocyanate. Such products are typically produced by the reaction of a diisocyanate reacted with one equivalent of a hydroxyalkyl ester of acrylic or methacrylic acid followed by the trimerization reaction of the remaining free isocyanate.

It is understood that during the formation of the isocyanurate, a diisocyanate may participate in the formation of two isocyanurate rings thereby forming crosslinked structures in which the isocyanurate rings may be linked by the diisocyanate used. Polyiisocyanates might also be used to increase this type of crosslink formation.

Diisocyanates suitable for preparing the urethane poly(acrylate) are well known in the art and include aromatic, aliphatic, and cycloaliphatic diisocyanates. Such isocyanates may be extended with small amounts of glycols to lower their melting point and provide a liquid isocyanate.

The hydroxyalkyl esters suitable for final reaction with the polyisocyanate formed from the polyol and diisocyanate are exemplified by hydroxylacrylate, hydroxypropyl acrylate, hydroxyethyl methacrylate, and hydroxypropyl methacrylate. Any acrylate or methacrylate ester or amide containing an isocyanate reactive group may be used herein, however. Other alcohols containing one hydroxyl group may also be used. The monoalcohols may be monomeric or polymeric.

Such unsaturated isocyanurates are described in, for example, U.S. Pat. No. 4,195,146.

5) Polyamide Ester Acrylates.

Poly(amide-esters) as characterized by the following empirical formula: 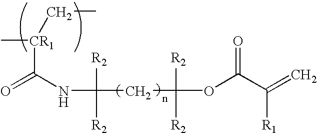
wherein R₁ is independently hydrogen or methyl, R₂ is independently hydrogen or lower alkyl, and h is 0 or 1. These compounds are typically the reaction product of a vinyl addition prepolymer having a plurality of pendant oxazoline or 5,6-dihydro-4H-1,3-oxazine groups with acrylic or methacrylic acid. Such poly(amide-esters) are described in, for example, British Pat. No. 1,490,308.

A poly(acrylamide) or poly(acrylate-acrylamide) characterized by the following empirical formula: 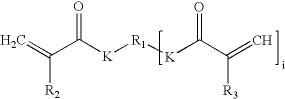
wherein R₁ is the polyvalent residue of an organic polyhydric amine or polyhydric aminoalcohol which contained primary or secondary amino groups bonded to different carbon atoms or, in the case of an aminoalcohol, amine and alcohol groups bonded to different carbon atoms; R₂ and R₃ are independently hydrogen or methyl; K is independently —O— or 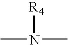
R₄ is hydrogen or lower alkyl; and i is 1 to 3.

The polyhydric amines suitable for preparing the poly(acrylamide) contains at least two carbon atoms and may contain 2 to 4, inclusive, amine or alcohol groups, with the proviso that at least one group is a primary or a secondary amine. These include alkane aminoalcohols and aromatic containing aminoalcohols. Also included are polyhydric aminoalcohols containing ether, amino, amide, and ester groups in the organic residue.

Examples of the above compounds are described, in for example, Japanese publications Nos. JP80030502, JP80030503, and JP800330504 and U.S. Pat. No. 3,470,079 and British Patent No. 905,186.

It is understood by those skilled in the art that the thermosetable organic materials described, supra, are only representative of those which may be used in the practice of this invention.

6) Saturated Polyesters, Polyethers, and Urethanes.

Saturated polyesters, polyethers, and polyurethanes that may also be used in this invention include, for example, those described in U.S. Pat. Nos. 4,871,811, 3,427,346 and 4,760,111. The saturated polyester resins and polyurethanes are particularly useful in hand lay-up, spray up, sheet molding compounding, hot melt adhesives and pressure sensitive adhesives applications. Appropriate saturated polyester resins include, but are not limited to, crystalline and amorphous resins. The resins may be formed by any suitable technique. For example, the saturated polyester resin may be formed by the polycondensation of an aromatic or aliphatic di- or polycarboxylic acid and an aliphatic or alicyclic di- or polyol or its prepolymer. Optionally, either the polyols may be added in an excess to obtain hydroxyl end groups or the dicarboxylic monomers may be added in an excess to obtain carboxylic end groups. Suitable polyurethane resins may be formed by the reaction of diols or polyols as those described in U.S. Pat. No. 4,760,111 and diisocyanates. The diols are added in an excess to obtain hydroxyl terminal groups at the chain ends of the polyurethane. The saturated polyesters and polyurethanes may also contain other various components such as, for example, an ethylene-vinyl acetate copolymer, an ethylene-ethyl acrylate copolymer, and the like.

### Thermoplastic Polymers—Low Profile Agents

Thermoplastic polymeric materials which reduce shrinkage during molding can also be included in the composition of the invention. These thermoplastic materials can be used to produce molded articles having surfaces of improve smoothness. The thermoplastic resin is added into the unsaturated polyester composition according to the invention in order to suppress shrinkage at the time of curing. The thermoplastic resin is provided in a liquid form and is prepared in such a manner that 30 to 45 percent by weight of the thermoplastic resin is dissolved in 55 to 70 percent by weight of polymerizable monomer having some polymerizable double bond in one molecule. Examples of the thermoplastic resin may include styrene-base polymers, polyethylene, polyvinyl acetate base polymer, polyvinyl chloride polymers, polyethyl methacrylate, polymethyl methacrylate or copolymers, ABS copolymers, Hydrogenated ABS, polycaprolactone, polyurethanes, butadiene styrene copolymer, and saturated polyester resins. Additional examples of thermoplastics are copolymers of: vinyl chloride and vinyl acetate; vinyl acetate and acrylic acid or methacrylic acid; styrene and acrylonitrile; styrene acrylic acid and allyl acrylates or methacrylates; methyl methacrylate and alkyl ester of acrylic acid; methyl methacrylate and styrene; methyl methacrylate and acrylamide. In the resin composition according to the invention, 5 to 50 percent by weight of the liquid thermoplastic resin is mixed; preferably 10 to 30 percent by weight of the liquid thermoplastic resin is mixed.

Low profile agents (LPA) are composed primarily of thermoplastic polymeric materials. These thermoplastic intermediates present some problems remaining compatible with almost all types of thermosetting resin systems. The incompatibility between the polymeric materials introduces processing difficulties due to the poor homogeneity between the resins. Problems encountered due to phase separation in the resin mixture include, scumming, poor color uniformity, low surface smoothness and low gloss. It is therefore important to incorporate components that the will help on stabilizing the resin mixture to obtain homogeneous systems that will not separate after their preparation. For this purpose, a variety of stabilizers can be used in the present invention which includes block copolymers from polystyrene-polyethylene oxide as those described in U.S. Pat. Nos. 3,836,600 and 3,947,422. Block copolymer stabilizers made from styrene and a half ester of maleic anhydride containing polyethylene oxide as described in U.S. Pat. No. 3,947,422. Also useful stabilizers are saturated polyesters prepared from hexanediol, adipic acid and polyethylene oxide available from BYK Chemie under code number W-972. Other type of stabilizers may also include addition type polymers prepared from vinyl acetate block copolymer and a saturated polyester as described in Japanese Unexamined Patent Application No. Hei 3-174424.

### Fatty Acid Intermediates

Fatty acids may be used in the preparation of polyesters without restriction and used in the present invention. Prepolymerized fatty acids or their fatty acid esters prepared according to known processes are usually used. A polybasic polymerized fatty acid prepared by polymerizing a higher fatty acid or higher fatty acid ester is preferable because it can provide better adhesiveness, flexibility, water resistant and heat resistance with improved properties. The fatty acid may be any of saturated and unsaturated fatty acids, and the number of carbons may be from 8 to 30, preferably 12 to 24, and further preferably 16 to 20 such as methyl, ethyl, propyl, butyl, amyl and cyclohexyl esters and the like.

Preferable polymerized fatty acids include polymerized products of unsaturated higher fatty acids such as oleic acid, linoleic acid, resinoleic acid, eleacostearic acid and the like. Polymerized products of tall oil fatty acid, beef tallow fatty acid and the like, can be also used. Hydrogenated polymerized fatty esters or oils can also be used. Portions of the dibasic carboxylic acid (herein after referred to as “dimer acid”) and three or higher basic carboxylic acid in the polymerized fatty acid is not limited, and the proportions may be selected appropriately according to the ultimate properties expected. Trimer acids or higher carboxylic acids may also be used.

The polymerization of the fatty acid esters is not particularly limited. Alkyl esters of the above mentioned polymerized fatty acids are usually used as the polymerized fatty acid esters. As said alkyl esters such as methyl ester, ethyl ester, propyl ester, isopropyl ester, butyl ester, amyl ester, hexyl ester and the like and higher alkyl esters such as octyl ester, decyl ester, dodecyl ester, pentadecyl ester, octadecyl ester and the like can be used, among which preferable are lower alkyl esters and more preferable are methyl ester, ethyl ester and butyl ester.

These polymerized fatty acids and polymerized fatty acid esters can be used either alone or in combinations of two or more. The proportion of the sum of the polymerized fatty acids and the polymerized fatty acid esters in the total polybasic carboxylic acid is not particularly limited and may be used in different rations ranging from 3 to 40% by weight of the resin composition.

### Epoxy Intermediates

Also compounds that may be included in this invention are a wide variety of epoxy compounds. Typically, the epoxy compounds are epoxy resins which are also referred as polyepoxides. Polyepoxides useful herein can be monomeric (i.e. the diglycidyl ether of bisphenol A), advanced higher molecular weight resins, or unsaturated monoepoxides (i.e., glycidyl acrylates, glycidyl methacrylates, allyl glycidyl ether, etc.) polymerized to homopolymers or copolymers. Most desirable, the epoxy compounds contain, on the average, at least one pendant or terminal 1,2-epoxy group (i.e., vicinal epoxy group per molecule).

Examples of the useful polyepoxides include the polyglicidyl ethers of both polyhydric alcohols and polyhydric phenols, polyglycidyl amines, polyglycidyl amides, polyglycidyl imides, polyglycidyl hydantoins, polyglycidyl thioethers, polyglycidyl fatty acids, or drying oils, epoxidized polyolefins, epoxidized di-unsaturated acid esters, epoxidized unsaturated polyesters, and mixtures thereof. Numerous epoxides prepared from polyhydric phenols include those which are disclosed, for example, in U.S. Pat. No. 4,431,782. Polyepoxides can be prepared from mono-, di- and trihydric phenols, and can include the novolac resins. The polyepoxides can include epoxidized cycloolefins; as well as polymeric polyepoxides which are polymers and copolymers of glycidyl acrylates, glycidyl methacrylate and allylglycidyl ether. Suitable polyepoxides are disclosed in U.S. Pat. Nos. 3,804,735; 3,893,829; 3,948,698; 4,014,771 and 4,119,609; and Lee and Naville, Handbook of Epoxy Resins, Chapter 2, McGraw Hill, New York (1967).

While the invention is applicable to a variety of polyepoxides, generally preferred polyepoxides are glycidyl polyethers of polyhydric alcohols or polyhydric phenols having weights per epoxide of 150 to 2,000. These polyepoxides are usually made by reacting at least two moles of an epihalohydrin or glycerol dihalohydrin with one mole of the polyhydric alcohol or polyhydric phenol, and sufficient amount of a caustic alkali to combine with the halogen of the halohydrin. The products are characterized by the presence of more than one epoxide group, i.e., a 1,2-epoxy equivalency greater than one.

The compositions may also include a monoepoxide, such as butyl glycidyl ether, phenyl glycidyl ether, or cresyl glycidyl ether, as a reactive diluent. Such reactive diluents are commonly added to polyepoxide formulations to reduce the working viscosity thereof, and to give better wetting to the formulation.

### Dilution Monomers

A vinyl monomer may also be included as a diluent with the vinyl esters, urethanes, unsaturated and saturated resins. Suitable monomers may include those such as, styrene and styrene derivatives such as alpha-methyl styrene, p-methyl styrene, divinyl benzene, divinyl toluene, ethyl styrene, vinyl toluene, tert-butyl styrene, monochloro styrene, dichloro styrene, vinyl benzyl chloride, fluorostyrene, and alkoxystyrenes (e.g., paramethoxy styrene). Other monomers which may be used include, for example, diallyl phthalate, hexyl acrylate, octyl acrylate, octyl methacrylate, diallyl itaconate, diallyl maleate, hydroxyethyl acrylate, hydroxyethyl methacrylate, hydroxypropyl acrylate and hydroxypropyl methacrylate. Mixtures of the above may also be employed.

Any suitable polyfunctional acrylate may be used in the resin composition, for example, ethylene glycol dimethacrylate, butanediol dimethacrylate, hexanediol dimethacrylate, ethoxylated trimethylol propane triacrylate, trimethylolpropane tri(meth)acrylate, trimethylolpropane triacrylate, trimethylolmethane tetramethacrylate, pentaerythritol tetramethacrylate, dipentaerythritol tetramethacrylate, dipentaerythritol pentamethacrylate, dipentaerythritol hexamethacrylate, ethoxylated polyhydric phenol diacrylates and dimethacrylates containing from 1 to 30 ethylene oxide units per OH group in the phenol, propoxylated polyhydric phenol diacrylates and dimethacrylates containing from 1 to 30 propylene oxide groups per OH groups in the phenol. Examples of some useful di- and polyhydric phenols include catechol; resorcinol; hydroquinone; 4,4′-biphenol; 4,4′-ispropylidenebis(o-cresol); 4,4′-isopropylidenebis(2-phenyl phenol); alkylidenediphenols such as bisphenol “A”; pyrogallol; phloroglucidol; naphthalene diols; phenol/formaldehyde resins; resorcinol/formaldehyde resins; and phenol/resorcinol/formaldehyde resins. Mixtures of the above di- and polyacrylates may also be employed.

The vinyl monomers and polyfunctional acrylates used with the vinyl esters, unsaturated polyesters, saturated polyesters, and polyurethanes may be used in varying amounts, preferably from about 10 to 50 based on the weight of the components which may be dissolved therein and more preferably from about 20 to 40 weight percent.

Other monomers that may be included in the compositions of the present invention are acetyl acetonates that can be monofunctional or polyfunctional. Examples include but are not limited to methyl acetoacetate, ethyl acetoacetate, t-butyl acetoacetate, 2thylhexyl acetoacetate, lauryl acetoacetate, acetoacetanilide, butanediol diacetoacetate, 1,6-hexanediol diacetoacetate, neopentyl glycol diacetoacetate, cyclohexane dimethanol diacetoacetate, ethoxylated bisphenol A diacetoacetate, trimethylolpropane triacetoacetate, glycerin triacetoacetate, polycaprolantone triacetoacetate, pentaerythritol tetraacetoacetate.

### Inhibitor in Resin Mixtures

Additives may also include inhibitors added to the resin mix to stop or delay any crosslinking chain reaction that might be started by the possible formation of free radicals. Because free radicals can be formed at the carbon-carbon double bonds through several different mechanisms, such as interactions between molecules with heat and light, the possibility of the formation of free radicals is quite high. Should this occur there is a good possibility that the resin could crosslink during its storage. Therefore, the right amount of inhibitor in the system is necessary to minimize stability problems. Suitable inhibitors may include but are not limited to, hydroquinone (HQ), tolu-hydroquinone (THQ), bisphenol “A” (BPA), naphthoquihone (NQ), p-benzoquinone (p-BQ), butylated hydroxy toluene (BHT), Hydroquinone monomethyl ether (HQMME), monotertiary butyl hydroquinone (MTBHQ), ditertiary Butyl hydroquinone (DTBHQ), tertiary butyl catechol (TBC), and other substituted and un-substituted phenols and mixtures of the above. All nitroxide initiators can also be used as inhibitors in the present invention.

### Fiber Reinforcement

The addition of fiber(s) provides a means for strengthening or stiffening the polymerized cured composition. The types often used are:

Inorganic crystals or polymers, e.g., fibrous glass, quartz fibers, silica fibers, fibrous ceramics, e.g., alumina-silica (refractory ceramic fibers); boron fibers, silicon carbide, silicon carbide whiskers or monofilament, metal oxide fibers, including alumina-boric-silica, alumina-chromia-silica, zirconia-silica, and others;

Organic polymer fibers, e.g., fibrous carbon, fibrous graphite, acetates, acrylics (including acrylonitrile), aliphatic polyamides (e.g. nylon), aromatic polyamides, olefins (e.g., polypropylenes, polyesters, ultrahigh molecular weight polyethylenes), polyurethanes (e.g., Spandex), alpha-cellulose, cellulose, regenerated cellulose (e.g., rayon), jutes, sisal, vinyl chlorides, vinylidenes, flax, and thermoplastic fibers;

Metal fibers, e.g., aluminum, boron, bronze, chromium, nickel, stainless steel, titanium or their alloys; and “whiskers”, single, inorganic crystals.

### Fillers

Suitable non-fibrous fillers are inert, particulate additives being essentially a means of reducing the cost of the final product while often reducing some of the physical properties of the polymerized cured compound. Fillers used in the invention include calcium carbonate of various form and origins, silica of various forms and origins, silicates, silicon dioxides of various forms and origins, clays of various forms and origins, feldspar, kaolin, flax, zirconia, calcium sulfates, micas, talcs, wood in various forms, glass (milled, platelets, spheres, micro-balloons), plastics (milled, platelets, spheres, micro-balloons), recycled polymer composite particles, metals in various forms, metallic oxides or hydroxides (except those that alter shelf life or viscosity), metal hydrides or metal hydrates, carbon particles or granules, alumina, alumina powder, aramid, bronze, carbon black, carbon fiber, cellulose, alpha cellulose, coal (powder), cotton, fibrous glass, graphite, jute, molybdenum, nylon, orlon, rayon, silica amorphous, sisal fibers, fluorocarbons and wood flour.

The fibrous materials may be incorporated into the resin in accordance with techniques which are known in the art. Fillers may include but are not limited to calcium carbonate, calcium sulfate, talc, aluminum oxide, aluminum hydroxide, silica gel, barite, carbon powder, etc. Preferably, the filler is added in amount between 0 to 80% by weight and more preferably in an amount of 20 to 60% by weight based on the resin composition.

### Thickening Agents

Optionally a thickening agent is added if compositions are used for Bulk Molding Compounding, Sheer Molding compounding, in the range of 0.05 to 10 percent, preferably in the range of 0.2 to 5 percent by weight of the chemical thickener, based on the weight of the molding compound. The thickening agent is added to facilitate increasing the viscosity of the compounding mixture. Examples include CaO, Ca(OH)₂, MgO or Mg(OH)₂. Any suitable chemical thickener contemplated by one skill in the molding compound art may be used. The thickening agent(s) coordinate with carboxyl groups present in the polymer of the present invention or to any other polymer added therewith from those described above.

Other thickening agents that may also be included are isocyanates. These materials react with hydroxyl groups that may be present in the polymers of this invention or in other polymer added therewith from those described above. Polyisocyanates employed in the present invention are aromatic, aliphatic and cycloaliphatic polyisocyanates having 2 or more isocyanate groups per molecule and having an isocyanate equivalent weight of less than 300. Preferably the isocyanates are essentially free from ethylenic unsaturation and have no other substituents capable of reacting with the unsaturated polyester. Polyfunctional isocyanates which are used in the above reactions are well known to the skilled artisan. For the purposes of the invention, diisocyantes include aliphatic, cycloaliphatic, araliphatic, aromatic and heterocyclic diisocyantes of the type described, for example, by W. Siefken in Justus Liebigs Annalen der Chemie, 562, pages 75 to 136, (1949) for example, those corresponding to the following formula:
OCN—R—(NCO)ₙ
wherein n is equal to 1 to 3 and R represents a difunctional aliphatic, cycloaliphatic, aromatic, or araliphatic radical having from about 4 to 25 carbon atoms, preferably 4 to 15 carbon atoms, and free of any group which can react with isocyanate groups. Exemplary diisocyantes include, but are not limited to, toluene diisocyanate; 1,4-tetramethylene diisocyanate; 1,4-hexamethylene diisocyanate; 1,6-hexamethylene diisocyanate; 1,12-dodecane diisocyanate; cyclobutane-1,3-diisocyanate; cyclohexane-1,3-diisocyanate; cyclohexane-1,4-diisocyanate; 1-isocyanato-3,3,5-trimethyl-5-isocyanatomethyl cyclohexane; 2,4-hexahydrotolylene diisocyanate; 2,6-hexahydrotolylene diisocyanate; 2,6-hexahydro-1,3-phenylene diisocyanate; 2,6-hexahydro-1,4-phenylene diisocyanate; per-hydro-2,4′-diphenyl methane diisocyanate; per-hydro-4,4′-diphenyl methane diisocyanate; 1,3-phenylene diisocyanate; 1,4-phenylene diisocyanate; 2,4-tolylene diisocyanate, 2,6-toluene diisocyanates; biphenyl methane-2,4′-diisocyanate; biphenyl methane-4,4′-diisocyanate; naphthalene-1,5-diisocyanate; 1,3-xylylene diisocyanate; 1,4-xylylene diisocyanate; 4,4′-methylene-bis(cyclohexyl isocyanate); 4,4′-isopropyl-bis-(cyclohexyl isocyanate); 1,4-cyclohexyl diisocyanate; 3-isocyanatomethyl-3,5,5-trimethylcyclohexyl isocyanate (IPDI); 1-methyoxy-2,4-phenylene diisocyanate; 1-chloropyhenyl-2,4-diisocyante; p-(1-isocyanatoethyl)-phenyl isocyanate; m-(3-isocyanatobutyl)-phenyl isocyanate; and 4-(2-isocyanate-cyclohexyl-methyl)-phenyl isocyanate. Mixtures of any of the above may be employed. When deemed appropriate, a diisocyanate may be employed which contains other functional groups such as amino functionality.

The preferred polyfunctional isocyanate additive of the molding compositions of this invention consists of a dual-functional additive prepared by the one step-addition reaction between one equivalent weight of a diol or triol of molecular weight from 60 to 3000 and an excess of the polyfunctional isocyanate. The polyfunctional isocyanate excess is added in a quantity sufficient to allow unreacted polyfunctional isocyanate remain free in the mixture after the reaction with the diol or triol in an amount of 0.01 to 50 percent by weight of the total mixture and most preferable in an amount of 1 to 30 percent by weight of the mixture. In the reaction involving the diol or triol with the polyfunctional isocyanate, it is preferred to employ a catalyst. A number of catalysts know to the skill artisan may be used for this purpose. Suitable catalysts are described in U.S. Pat. Nos. 5,925,409 and 4,857,579, the disclosures of which are hereby incorporated by reference. Examples of the polyhydric alcohol having at least 2 hydroxyl groups in the molecule and a hydroxyl value of 35 to 1,100 mgKOH/g include ethylene glycol, propylene glycol, diethylene glycol, triethylene glycol, 1,5-pentane diol, 1,6-hexane diol, polyethylene glycol and polypropylene having a molecular weight of 200 to 3000, polytetramethylene glycol having a molecular weight of 200 to 3000, etc.

The process of the invention may employ a carbodiimide, preferably a carbodiimide intermediate containing from about 1 to about 1000 repeating units. Polycarbodiimides are preferably utilized. The carbodiimides depending on the amount added are used to react with the resin or components having active hydrogens. For example to lower the acid number of the unsaturated polyester resin or to increase the viscosities of the resins to form a gel like material. Exemplary carbodiimides are described in U.S. Pat. No. 5,115,072 to Nava et al., the disclosure of which is incorporated herein by reference in its entirety.

In general, the carbodiimides preferably are polycarbodiimides that include aliphatic, cycloaliphatic, or aromatic polycarbodiimides. The polycarbodiimides can be prepared by a number of reaction schemes known to those skilled in the art. For example, the polycarbodiimides may be synthesized by reacting an isocyanate-containing intermediate and a diisocyanate under suitable reaction conditions. The isocyanate containing intermediate may be formed by the reaction between a component, typically a monomer containing active hydrogens, and a diisocyanate. Included are also polycarbodiimides prepared by the polymerization of isocyanates to form a polycarbodiimide, which subsequently react with a component containing active hydrogens.

Preferably, the carbodiimide intermediate is represented by the formula selected from the group consisting of: 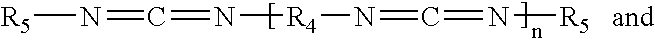 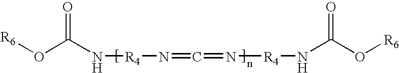
wherein:

R₄ and R₅ are independently selected from the group consisting of alkyl, aryl, and a compound containing at least one radical;

R₆ may be a monomeric unit or a polymeric unit having from 1 to 1000 repeating units; and

n ranges from 0 to 100;

The carbodiimide is preferably used in a percentage ranging from about 0.10 to about 50% by weight based on the weight of reactants, and more preferably from about 1 to about 20 percent by weight.

### Other Additives

The term “additive” is understood to mean any product which is used to modify the properties of the polymer. For example in the preparation of blends the used of toughening agents to increase the mechanical properties of the resulting cured material, addition of UV stabilizers to prevent degradation by UV radiation.

Additives include phenolic type antioxidants as those described in pages 1 to 104 in “Plastic additives”, by R. Gächter and Müller, Hanser Publishers, 1990. Include also are Mannich type antioxidants, specially phenols and naphthols, suitable for the purpose herein include hindered aromatic alcohols, such as hindered phenols and naphthols, for example, those described in U.S. Pat. No. 4,324,717, the disclosure of which is incorporated herein by reference in its entirety.

Additional additives known by the skilled artisan may be employed in the resin composition of the present invention including, for example, paraffins, lubricants, flow agents, air release agents, flow agents, wetting agents, UV stabilizers, radiation curing initiators (i.e., UV curing initiators) and shrink-reducing additives. Various percentages of these additives can be used in the resin compositions.

Internal release agents are preferably added to the molding composition according to the invention. Aliphatic metal slats such as zinc stearate, magnesium stearate, calcium stearate or aluminum stearate can be used as the internal release agent. The amount of internal release agent added is in the range of 0.5 to 5.0 percent by weight, more preferably in the range of from 0.4 to 4.0 percent by weight. Hence, stable release can be made at the time of demolding without occurrence of any crack on the molded product.

Acrylic resins prepared by radical polymerization may be used in the mixtures. The acrylic resin preferably has an acid number ranging from about 1 to 100 mg of KOH/g, more preferably from about 5 to 50 mg of KOH/g, and most preferably from about 10 to 30 mg of KOH/g. The acrylic resin preferably has a hydroxyl number ranging from 5 to 300, more preferably from about 25 to 200, and most preferably from 50 to 150. The acrylic resin has a preferred number average molecular weight, determined by GPC versus polystyrene standards, from about 1000 to about 100,000, and more preferably from about 2000 to about 50,000. The acrylic resin has a polydispersity preferably from about 1.5 to about 30, more preferably from about 2 to 15. The Tg of the acrylic resin, measured by Differential Scanning Calorimetry, is preferably from about −30° C. to about 150° C., and more preferably from about −10° C. to about 80° C.

The styrene acrylic resins which are used are preferably formed from about 0.5 to 30 percent by weight of a functional mercaptam which contains carboxyl, hydroxyl, siloxy, or sulfonic acid groups (most preferably from about 1 to 15 percent by weight), and from about 70 to about 99.5 percent by weight of an ethylenically unsaturated monomer (most preferably 85 to 99 percent by weight). Exemplary styrene/acrylic resins are described in Boutevin et al., Eur. Polym. J, 30; No. 5, pp. 615-619, and Rimmer et al., in Polymer, 37, No. 18, pp. 4135-4139. Also included are block copolymers of alkenyl aromatic hydrocarbons and alkylene oxides described in U.S. Pat. Nos. 3,050,511 and 3,836,600.

Various hydroxyl and carboxyl terminated rubbers may be also used as toughening agents. Examples of such materials are presented in U.S. Pat. No. 4,100,229, the disclosure of which is incorporated by reference herein in its entirety; and in J. P. Kennedy, in J. Macromol. Sci. Chem. A21, pp. 929(1984). Such rubbers include, for example, carbonyl-terminated and hydroxyl polydienes. Exemplary carbonyl-terminated polydienes are commercially available from BF Goodrich of Cleveland, Ohio, under the trade name of Hycar™. Exemplary hydroxyl-terminated Polydienes are commercially available from Atochem, Inc., of Malvern, Pa., and Shell Chemical of Houston, Tex.

A number of polysiloxanes may be used as toughening agents. Examples of suitable polysiloxanes include poly(alkylsiloxanes), (e.g., poly(dimethyl siloxane)), which includes compounds which contain silanol, carboxyl, and hydroxyl groups. Examples of polysiloxanes are described in Chiang and Shu, J. Appl. Pol. Sci. 361, pp. 889-1907, (1988).

Various hydroxyl and carboxyl terminated polyesters prepared from lactones (e.g., gamma-butyrolactone, etha-caprolactone), as described in Zhang and Wang, Macromol. Chem. Phys. 195, 2401-2407(1994); In't Velt et al, J. Polym. Sci. Part A, 35, 219-216(1997); Youqing et al, Polym. Bull. 37, 21-28(1996).

Various Telechelic Polymers as those described in “Telechelic Polymers: Synthesis and Applications”, Editor: Eric J. Goethals, CRC Press, Inc. 1989, are also included in this invention.

Various polyethoxylated and polypropoxylated hydroxyl terminated polyethers derived from alcohols, phenols (including alkyl phenols), and carboxylic acids can be used as toughening agents. Alcohols which may be used in forming these materials include, but are not limited to, tridecyl alcohol, lauryl alcohol, and mixtures thereof. Commercially suitable polyethoxylated and polypropoxylated oleyl alcohol are sold under the trade name of Rhodasurf™ by Rhone-Poulenc of Cranbury, N.J., along with Trycol™ by Emery Industries of Cincinnati, Ohio. Examples of phenols and alkyl phenols which may be used include, but are not limited to, octyl phenol, nonyl phenol, tristyrylphenol, and mixtures thereof. Commercially suitable tristyrylphenols include, but are not limited to, Igepal™ by Rhone-Poulenc, along with Triton™ by Rohm and Haas of Philadelphia, Pa.

### Organic Peroxide

The polymers, copolymers and oligomers of the present invention can be cured without any intended limitation of the process, at room temperature using a peroxide initiator, UV radiation, or at high temperature in molding processes. A variety of peroxides can be used such as those listed above as being used in the polymerization reactions of the present invention.

### Curing Accelerators/Promoters

Suitable curing accelerators or promoters may also be used and include without any intended limitation of the process, for example, cobalt naphthanate, cobalt octoate, N,N-diethyl aniline, acetyl acetonates, N,N-dimethyl aniline, N,N-dimethyl acetamide, and N,N-dimethyl p-toluidine. Other salts of lithium, potassium, zirconium, calcium and copper. Mixtures of the above may be used. The curing accelerators or promoters are preferably employed in amounts from about 0.005 to about 1.0 percent by weight, more preferably from about 0.1 to 0.5 percent by weight, and most preferably from about 0.1 to 0.3 percent by weight of the resin.

The unsaturated resins are particularly well suited for forming molded articles, including those used in storage tanks, automobile body panels, boat building, tub showers, culture marble, solid surface, polymer concrete, pipes and inner liners for pipeline reconstruction. Other applications include gelcoats and coatings. The unsaturated resins may be used alone or in conjunction with other appropriate materials. When the resins are used with other materials (e.g., fibrous reinforcements and fillers), they are typically used to form reinforced products such as storage tanks, automobile body panels, boat building, tub showers by any known process such as, for example pultrusion, sheet molding compounding (SMC), spray up, hand lay-up, resin transfer molding, vacuum injection molding, resin transfer molding and vacuum assisted resin transfer molding.

Several advantages are found on the resins from this invention. Since the products have a higher amount of carbon-carbon linkages than any typical thermoset resins containing ester or urethane linkages they are less sensitive to thermal and hydrolytic stability. Replacement of these ester linkages by simple but most stable carbon-carbon sigma bond leads to a more stable unsaturated thermoset resins to both hydrolytically, thermal and as well as chemically resistant. A critical problem with thermosetting resins is that their linear shrinkage can be as high as five percent for most common resins. In addition, the resins of this invention have hydroxyl groups that may be reacted with isocyanates or anhydrides and acid groups that may be reacted with other epoxy containing materials. The acid groups may also be use to coordinate with metal salts such magnesium, zinc or calcium oxide. These reactions are important in the preparation of products for SMC applications, pultrusion, adhesives, and open mold among others. The resins of this invention have low shrink properties alone or in combination with other thermoset or thermoplastic resins. Examples to illustrate these advantages are presented below.

Polymers, copolymers or oligomers of the present invention containing reactive functional groups that can undergo polymerization with other ethylenically unsaturated monomers or polymers are prepared by using styrenic monomers as the primary monomer in combination with a variety of ethylenically unsaturated monomers. For the purpose of this invention, it is preferable that low molecular weight polymers, copolymers and oligomers useful in the present invention are prepared by nitroxide mediated radical polymerization. The polymeric and/or oligomeric intermediates are prepared from ethylenically unsaturated type monomers that are incorporated as the repeating units in the backbone. The ethylenically unsaturated type monomers function both as solvent to carry out the polymerization and as reactive monomers to form the polymeric and/or oligomeric resin products. At least one of the monomers contains a reactive functional group that can further be reacted with other moieties. The functional groups contained in the monomers being reacted include but are not limited to hydroxyl, epoxy, phenol, thiol, amino, and other monomers containing active hydrogens. The preferred functionalities are epoxy, hydroxyl, carboxyl, amino and phenol.

The polystyrene intermediates containing the functional groups can further be reacted with other monomers containing ethylenically unsaturated moieties. For example polystyrene intermediates containing epoxy groups along the backbone, are further reacted with monomers such as acrylic or methacrylic acid. Another example may include the preparation of polystyrene intermediates containing hydroxyl functionality that can further be reacted with an isocyanate acrylate such as 2-isocyanatoethyl methacrylate. Diisocyanates reacted with one equivalent of hydroxyethyl methacrylate may also be used. Another example can include the preparation of polystyrene intermediates containing acid group functionality that can further be reacted with an acrylate or methacrylate containing epoxy functionality.

For the purpose of the present invention, both the polystyrene intermediates containing functional groups and preferably those containing reactive groups can be used to prepared curable compositions. Additionally, the polymeric and/or oligomeric intermediates may be combined with a variety of polymers to form mixtures with a large range of properties depending on the structure and nature of the materials in the mixture.

### Resins Used in Combination with the Unsaturated Polystyrene Thermosetting Resin

Described below are resins which have been co-reacted using the unsaturated polystyrene thermosetting resin. All resins are available from Reichhold, Inc., Durham, N.C. Polylite® 31051-00 is a DCPD/maleic anhydride/diethylene glycol resin used for open mold applications such as spray up and hand lay-up; Polylite® 33000-00 is a Propylene Glycol/Polyethylene Terephthalate/Maleic anhydride resin used in open mold applications; Polylite® 33420-00 is an Isophthalic/Maleic anhydride/Propylene glycol resin used in close molding applications and cure in place pipe; Hydrex® LS (33390-00) is a vinyl ester resin used in marine and other open applications; Polylite® 33282-08 is flexible general purpose DCPD laminating resin; Polylite® 31029-10 is an methyl propane diol/orthophthalic/maleic resin used in SMC and BMC applications; Polylite® 31815-00 is propylene glycol/ethylene glycol/orthophthalic/maleic laminating resin; Polylite® 31100-00 is an aromatic polyisocyanate prepolymer; CIPP 1070 is a modified polycarbodiimide resin intermediate; Isonate 143L is a polymeric phenalenyl isocyanate available from Dow Chemical; BPO—is benzoyl peroxide; MEKP—methyl ethyl ketone peroxide available from Atochem; DTBP—is di-t-butyl peroxide available from Atochem; DMA is dimethyl aniline; MTBHQ is mono-terbutyl hydroquinone; TOFA is Tall oil fatty acid; AA is acrylic acid.

### EXAMPLES

The following examples are provided to illustrate the present invention, and should not be construed as limited thereof. In the examples polymer molecular weights were determined by gel permeation chromatography in a liquid chromatographer equipped with a Waters Breeze 2414 RI refractometer and three styragel columns using tetrahydrofuran as the mobile phase at 40° C. The calibration of the system was accomplished using monodisperse polystyrene standards with a molecular weight of 2 million to 162 Daltons. Viscosities were measured with a Brookfield Viscometer with a spindle #3 at 30 rpm or spindle #2 at 20 at 25° C. in most cases. The type of spindle used in the measurements depended on the viscosity measured. Shrinkage measurements on the cured thermosetting resins were done according to the ASTM test method D2566-79. The surface smoothness of the SMC was measured on 10″×18″×0.1″ plaques using a Diffracto D-Sight AS-2 surface analyzer. Smoothness is expressed as a surface waviness index, which is generated by the SURF algorithm.

### Example 1

### Preparation of (Sample 1)

A 3 liter four-necked glass reactor equipped with a mechanical agitator, a reflux condenser, an N₂ inlet, and a temperature controlling mechanism was purged thoroughly with N₂ for a period of 5-10 min. 1480 grams of styrene, 7.5 grams of methacrylic acid (MAA), 2.73 grams of 4-hydroxy-2,2,6,6-tetramethylpiperidinyloxy free radical (4-hydroxy-TEMPO), and 2.86 grams of benzoyl peroxide 98% (BPO, Luperox A98) were introduced in the reactor.

The reaction mixture was purged with N₂ for 20 minutes minimum while heating was initiated. When the temperature reached 70° C., N₂ purging was stopped and a N₂ blanket was maintained thereafter during the entire reaction. The reactor was then brought to 120° C. with constant agitation. Samples were withdrawn under N₂ at the top heat and every hour thereafter and % non-volatiles (% NV) was determined gravimetrically. When the % NV reached a value of 28%, the reactor was cooled to 70° C. maximum. A solution of 1.0 grams Norac 46-702 (Methylethyl ketone peroxide, MEKP) dispersed in 9.0 grams of styrene was added into the 3 liter reactor and the reactor was heated to 100° C. with a N₂ blanket and constant agitation. The addition of MEKP decreased the color of the polymer solution. The temperature was maintained until the % NV of the reaction mixture was 40. The reactor was cooled to 32° C. maximum and the material filtered through a fine mesh paint filter. This material is the functional copolystyrene (Sample 1). Samples 2-7 in Table 1 were prepared in a similar fashion using the appropriate charges of 4-HydroxyTEMPO and BPO.

| | Sample | | | | | | |
|---|---|---|---|---|---|---|---|
| | 1 | 2 | 3 | 4 | 5 | 6 | 7 |
| Nitroxide | 0.18 | 0.28 | 0.28 | 1.10 | 1.10 | 1.10 | 1.15 |
| % NV | 40.5 | 40.7 | 58.5 | 55.5 | 66.4 | 33.0 | 9.3 |
| Visc. | 376 | 164 | 1988 | 654 | 14400 | 16 | 3.0 |
| Mₙ | 8070 | 19100 | 24900 | 7610 | 8180 | 2732 | 1141 |
| M_{w} | 40500 | 27500 | 32900 | 10800 | 11700 | 7083 | 2049 |
| M_{z} | 61000 | 36600 | 39400 | 12500 | 13500 | 8283 | 2718 |

Shrink measurements of resin 33390-00 and Sample 1 from Table 1 was determined using ASTM test method D2566-79. The ratios between the unsaturated polyester resin and Sample 1 are listed in Table 2.

TABLE 2
Select shrink bar studies of blends consisting of a UPR and Sample 1.

| Sample | UPR | % | % Sample 1 | % Shrinkage |
|---|---|---|---|---|
| 13 | 33390-00 | 90 | 10 | 1.11 |
| 14 | 33390-00 | 85 | 15 | 1.05 |
| 15 | 33390-00 | 80 | 20 | 0.94 |
| 16 | 33000-00 | 100 | 0 | 2.05 |
| 17 | 33000-00 | 85 | 15 | 1.64 |
| 18 | 33000-00 | 70 | 30 | 1.68 |
| 19 | 33282-08 | 60 | 40 | 0.51 |
| 20 | 33420-00 | 100 | 0 | 1.92 |
| 21 | 33420-00 | 65 | 35 | 1.79 |

* Typical conditions for Samples 20-21: Promote blend with 0.2 pph 12% Cobalt Octoate, 0.1 pph DMA, and 50 ppm MTBHQ. Initiate with 1.25 pph MEKP 46-709 and pour into shrink bar. After 2 hours at 25° C., post-cure 1 hour at 60° C. and 2 hours at 120° C. Cool overnight and measure linear shrinkage and Barcol. Samples 13-19 are provided prepromoted and only peroxide was used to cure the resins.

Shrinkage measurements on the cured thermosetting resins were done according to the ASTM test method D2566-79. The surface smoothness of the SMC was measured on 10″×18″×0.1″ plaques using a Diffracto D-Sight AS-2 surface analyzer and they are summarized in Table 3. The SMC mixture used in the surface analysis was as follows:

| 1. Polylite 31029-00 | 80 parts. |
|---|---|
| 2. Polystyrene solution | 20 parts. |
| 3. TBPB | 1.5 parts. |
| 4. Zinc Stearate | 4 parts. |
| 5. Pigment | 3 parts. |
| 6. Calcium Carbonate | 180 parts. |
| 7. Thickener P69033 | 1.8 parts. |
| 8. Glass Fiber | 20% |

TABLE 3
Shrinkage and Diffracto study of blends made with functional
copolystyrenes of various molecular weights (Styrene:MAA
ratio is 199:1) and DION ® 31029-10.

| Properties/ | Sample 8 | | | | |
|---|---|---|---|---|---|
| Sample | (control) | Sample 9 | Sample 10 | Sample 11 | Sample 12 |
| Molecular | 104,000 | 50,000 | 31,000 | 46,000 | 40,000 |
| weight Mn of | | | | | |
| PS | | | | | |
| Shrinkage | 0.0022 | 0.0024 | 0.0024 | 0.0021 | 0.0022 |
| mm/14 inch | | | | | |
| (cold plate, cold | | | | | |
| mold) | | | | | |
| Diffracto # | 190 | 170 | 260 | 145 | 155 |
| (Average) | | | | | |

In order to establish the advantages of adding an extra amount of peroxide at the end of the polymerization, the experiments below compare polymers with and without an extra amount of peroxide. The results show that lower color is obtained when a small amount of peroxide is added at the end.

TABLE 4
APHA color comparison for functional copolystyrene
(Styrene:MAA ratio is 199:1)

| Sample | APHA | Viscosity | % NV |
|---|---|---|---|
| 1 | 30 | 376 | 40.5 |
| 22 | 80 | 476 | 39.7 |
| 23 | 10 | 2132 | 45.1 |

Sample 22 prepared similar to procedure for Sample 1 except that MEKP was not added. Sample 23 was prepared in a similar way to Sample 22 except that di-t-butyl-perbenzoate (DTBP) was used instead of BPO.

### Example 2

### Preparation of (Sample 28)

A 3 liter four-necked glass reactor equipped with a mechanical agitator, a reflux condenser, an N₂ inlet, and a temperature controlling mechanism was purged thoroughly with N₂ for a period of 5-10 min. 1353 Grams of styrene, 135 grams of glycidyl methacrylate (GMA), 8.4 grams of 4-hydroxy-2,2,6,6-tetramethylpiperidinyloxy free radical (4-Hydroxy-TEMPO), and 8.8 grams of benzoyl peroxide 98% (BPO, Luperox A98) were introduced in the reactor.

The reaction mixture was purged with N₂ for 20 minutes minimum while heating was initiated. When the temperature reached 70° C., N₂ purging was stopped and a N₂ blanket was maintained thereafter during the entire reaction. The reactor was then brought to 120° C. with constant agitation. Samples were withdrawn under N₂ at the top heat and every hour thereafter and % NV was determined gravimetrically. When the NV reached a value of 29%, the reactor was cooled to 70° C. maximum. A solution of 1.0 grams Norac 46-702 (MEKP) dispersed in 9.0 grams of styrene was added into the 3 liter reactor and the reactor was heated to 100° C. with a N₂ blanket and constant agitation. The temperature was maintained until the % NV of the reaction mixture was 54. The reactor was cooled to 32° C. maximum and the material filtered through a fine mesh paint filter. This material is the functional copolystyrene (Sample 28). Samples 24-40 in Tables 5 and 6 were prepared in a similar fashion using the appropriate charges of 4-HydroxyTEMPO and BPO.

### Example 3

### Preparation of (Sample 41)

A 3 liter four-necked glass reactor equipped with a mechanical agitator, a reflux condenser, an N₂ inlet, and a temperature controlling mechanism was purged thoroughly with N₂ for a period of 5-10 min. 1421 Grams of styrene, 68 grams of maleic anhydride (MA), 8.4 grams of 2,2,6,6-tetramethylpiperidinyloxy free radical (TEMPO), and 8.8 grams of benzoyl peroxide 98% (BPO, Luperox A98) were introduced in the reactor.

The reaction mixture was purged with N₂ for 20 minutes minimum while heating was initiated. When the temperature reached 70° C., N₂ purging was stopped and a N₂ blanket was maintained thereafter during the entire reaction. The reactor was then brought to 110° C. with constant agitation. Samples were withdrawn under N₂ at the top heat and every hour thereafter and % NV was determined gravimetrically. When the NV reached a value of 52%, the reactor was cooled to 32° C. maximum and the material filtered through a fine mesh paint filter. This material is the functional copolystyrene (Sample 41).

### Example 4

### Preparation of (Sample 42)

A 3 liter four-necked glass reactor equipped with a mechanical agitator, a reflux condenser, an N₂ inlet, and a temperature controlling mechanism was purged thoroughly with N₂ for a period of 5-10 min. 1353 Grams of styrene, 49 grams of maleic anhydride (MA), 8.4 grams of 2,2,6,6-tetramethylpiperidinyloxy free radical (TEMPO), and 8.8 grams of benzoyl peroxide 98% (BPO, Luperox A98) were introduced in the reactor.

The reaction mixture was purged with N₂ for 20 minutes minimum while heating was initiated. When the temperature reached 70° C., N₂ purging was stopped and a N₂ blanket was maintained thereafter during the entire reaction. The reactor was then brought to 110° C. with constant agitation. Samples were withdrawn under N₂ at the top heat and every half hour thereafter and % NV was determined gravimetrically throughout the entire reaction. When the NV reached a value of 15%, 46 g of maleic anhydride were introduced to the reactor and the temperature maintained at 110° C. When the NV reached a value of 33%, 41 g of maleic anhydride were introduced to the reactor and the temperature maintained at 110° C. When the NV reached a value of 48%, the reactor was cooled to 32° C. maximum and the material filtered through a fine mesh paint filter. This material is the functional copolystyrene (Sample 42). Sample 43 in Tables 5 and 6 was also prepared in a similar fashion using the appropriate charges of reactants.

TABLE 5
Functional copolymer sample compositions

| Sam- | | | | | | | | |
|---|---|---|---|---|---|---|---|---|
| ple | Styrene | MAA | GMA | HEMA | MMA | BMA | MA | DMAA |
| 24 | 98.5 | 1.5 | | | | | | |
| 25 | 97.0 | 1.5 | | 1.5 | | | | |
| 26 | 97 | 3.0 | | | | | | |
| 27 | 97 | | 3.0 | | | | | |
| 28 | 90 | | 10 | | | | | |
| 29 | 90 | | | | | | | 10 |
| 30 | 97 | | | | | | | 3 |
| 31 | 93.6 | | 6.4 | | | | | |
| 32 | 95.6 | | 4.4 | | | | | |
| 33 | 93.6 | | 6.4 | | | | | |
| 34 | 95.6 | | 4.4 | | | | | |
| 35 | 91 | | 4.5 | | 4.5 | | | |
| 36 | 91 | | 2.2 | | 6.8 | | | |
| 37 | 91 | | 4.5 | | | 4.5 | | |
| 38 | 91 | | 2.2 | | | 6.8 | | |
| 39 | 90 | | | 10 | | | | |
| 40 | 81 | | | 19 | | | | |
| 41 | 95 | | | | | | 5 | |
| 42 | 90 | | | | | | 10 | |
| 43 | 85 | | | | | | 15 | |

MAA = Methacrylic Acid;
GMA = Glycidyl Methacrylate;
HEMA = Hydroxyethyl Methacrylate;
MMA = Methyl Methacrylate;
BMA = Butyl Methacrylate;
MA = Maleic Anhydride;
DMAA = Dimethyl acrylamide.

TABLE 6
Functional copolymer sample properties

| | | % | | | | |
|---|---|---|---|---|---|---|
| Sample | Nitroxide | NV | Visc. | Mn | Mw | Rxn Time (hr) |
| 24 | 0.28 | 39.4 | 360 | 19700 | 28400 | 11 |
| 25 | 0.28 | 41.1 | 563 | 21100 | 30100 | 8 |
| 26 | 1.1 | 56.4 | 2760 | 7320 | 10900 | 25 |
| 27 | 1.1 | 56.3 | 700 | 6960 | 10400 | 24 |
| 28 | 0.55 | 54.4 | 1180 | 4640 | 18200 | 17 |
| 29 | 1.1 | 50.4 | 332 | 3117 | 10427 | 26 |
| 30 | 0.28 | 43.4 | 240 | 22328 | 27727 | 10 |
| 31 | 0.56 | 54.1 | 1156 | 17230 | 20396 | 16 |
| 32 | 0.56 | 54.2 | 984 | 16842 | 20072 | 17 |
| 33 | 0.56 | 53.4 | 804 | 16420 | 19551 | 16 |
| 34 | 0.56 | 54.7 | 1204 | 16814 | 19991 | 16 |
| 35 | 0.56 | 58.2 | 2488 | 17877 | 21088 | 14 |
| 36 | 0.56 | 54.7 | 1200 | 16976 | 20584 | 14 |
| 37 | 0.56 | 54.3 | 1120 | 15211 | 20159 | 14 |
| 38 | 0.56 | 52.7 | 908 | 17095 | 19958 | 14 |
| 39 | 0.56 | 53.6 | 1876 | 5099 | 21724 | 12 |
| 40 | 0.56 | 50.4 | 2316 | 17009 | 23052 | 12 |
| 41 | 0.56 | 52.6 | 5160 | 16332 | 21003 | 15 |
| 42 | 0.56 | 49.8 | 7000 | 5578 | 21985 | 5 |
| 43 | 0.56 | 47.8 | 6500+ | 4607 | 24931 | 4 |

Viscosity reported in cps.

Shrink measurements of resin 31051-00 and Sample 1 from Table 1 was determined using ASTM test method D2566-79. The ratios between the unsaturated polyester resin and Sample 1 are listed in Table 7.

TABLE 7
Linear Shrinkage for Non-filled Blends Made
From Functional Copolystyrenes

| | Resin 1 | 31051-00 | Additional | % Linear | Average |
|---|---|---|---|---|---|
| Sample | (pph) | pph | Styrene pph | Shrinkage* | Barcol* |
| 44 | — | 100 | 0 | 1.62 | NM |
| 45 | 27 (20) | 80 | 0 | 1.11 | NM |
| 46 | 35 (26.4) | 61.6 | 12 | 1.35 | 15^{a} |
| 47 | 35 (46) | 46 | 8 | 0.85 | 10 |
| 48 | 35 (67.2) | 28.8 | 4 | 0.38 | 15 |
| 49 | 36 (47) | 47 | 6 | 0.98 | 28 |
| 50 | 37 (26.7) | 62.3 | 11 | 1.11 | 17^{a} |
| 51 | 37 (47) | 47 | 6 | 0.76 | 20 |
| 52 | 37 (70) | 30 | 0 | 0.47 | 17 |
| 53 | 38 (48) | 48 | 4 | 0.84 | 27 |
| 54 | 39 (47) | 47 | 6 | 0.69 | 25 |
| 55 | 39 (44) | 44 | 12 | 0.61 | 22 |
| 56 | 41 (47) | 47 | 6 | 0.66 | 20 |

*Typical conditions for Samples 44-56: Promote blend with 0.2 pph 12% Cobalt Octoate, 0.1 pph DMA, and 50 ppm MTBHQ. Initiate with 1.25 pph MEKP 46-709 and pour into shrink bar. After 2 hours at 25° C., post-cure 1 hour at 60° C. and 2 hours at 120° C. Cool overnight and measure linear shrinkage and Barcol.
^{a}Measured prior to post-cure.

### Example 5

### Preparation of (Sample 61)

A 3 liter four-necked glass reactor equipped with a mechanical agitator, a reflux condenser, an N₂ inlet, a air inlet, and a temperature controlling mechanism was purged thoroughly with N₂ for a period of 5-10 min. 1207 Grams of Sample 28, 61 grams of glacial acrylic acid, 1.6 grams of a 80% ethyltriphenylphosphonium acid acetate (ETPPAA) solution, and 0.20 grams of THQ were then introduced in the reactor. The reactor was heated to 95° C. with an air sparge and a N₂ blanket with a constant agitation. The temperature was maintained for 5-7 hours until the acid number of the reaction mixture dropped from 54 to 10. The reactor was cooled to 32° C. maximum and the material filtered through a medium mesh paint filter. This material is the thermosetting reactive polystyrene (Sample 61). Examples 57-68 in Table 8 were also prepared in a similar fashion using the appropriate charges of reactants.

TABLE 8
Reactive copolymers using functional
copolymers as intermediates, properties.

| Sample | Intermed^{a}. | Pendant | % NV | Visc. | Mn | Mw |
|---|---|---|---|---|---|---|
| 57 | 26 | GMA | 58.7 | 2272 | 2460 | 11100 |
| 58 | 69 | MAA/TOFA | 59.6 | 976 | 2273 | 11698 |
| 59 | 69 | MAA/TOFA | 62.7 | 3850 | 3353 | 12805 |
| 60 | 70 | MAA/TOFA | 49.0 | 1256 | 30889 | 44204 |
| 61 | 28 | AA | 55.7 | 2800 | 17344 | 22279 |
| 62 | 69 | AA | 58.4 | 1872 | 3244 | 11473 |
| 63 | 32 | AA | 56.2 | 2080 | 16904 | 20560 |
| 64 | 31 | AA | 56.0 | 2376 | 17388 | 21506 |
| 65 | 33 | AA | 54.4 | 1704 | 16441 | 19902 |
| 66 | 34 | AA | 56.0 | 1750 | 17365 | 20839 |
| 67 | 35 | AA | 58.1 | 4480 | 5908 | 21782 |
| 68 | 37 | AA | 54.1 | 1412 | 4588 | 20840 |

* MAA = Methacrylic Acid, TOFA = Toll Fatty Acid, AA = Acrylic Acid
^{a}Intermediates selected from Tables 5 and 6 or, Intermediate 69 prepared as Sample 28, except using double the HydroxyTEMPO and BPO charges used in Sample 28. Intermediate 70 prepared as Sample 28, except using half the HydroxyTEMPO and BPO charges used in Sample 28.

Shrink measurements of resin 31815-00, 31051-00 and Sample 1 from Table 1 was determined using ASTM test method D2566-79. The ratios between the unsaturated polyester resin and Sample 1 are listed in Table 9.

TABLE 9
Linear Shrinkage for Non-filled Blends
Made From Reactive Copolystyrenes

| | | | Additional | | |
|---|---|---|---|---|---|
| Sam- | Resin 1 | | Styrene | % Linear | Average |
| ple | (pph) | Resin 2 (pph) | pph | Shrinkage* | Barcol* |
| 71 | — | 31815 (100) | 0 | 2.03 | NM |
| 72 | 58 (20) | 31815 (80) | 0 | 1.58 | NM |
| 73 | 59 (20) | 31815 (80) | 0 | 1.47 | NM |
| 74 | 60 (20) | 31815 (80) | 0 | 2.08 | NM |
| 75 | — | 31051 (100) | 0 | 1.62 | NM |
| 76 | 58 (50) | 31051 (50) | 0 | 0.86 | 28 |
| 77 | 58 (45.9) | 31051 (45.9) | 8.2 | 0.37 | 28 |
| 78 | 60 (50) | 31051 (50) | 0 | 1.62 | NM |
| 79 | 60 (65) | 31051 (35) | 0 | 0.53 | NM |
| 80 | 63 (46.5) | 31051 (46.5) | 7 | 0.56 | 32 |
| 81 | 63 (46.6) | 31051 (46.6) | 6.8 | 0.66 | 26 |
| 82 | 63 (43) | 31051 (43) | 14 | 0.40 | 33 |
| 83 | 63 (42.8) | 31051 (42.8) | 14.4 | 0.63 | 25 |
| 84 | 64 (46.9) | 31051 (46.9) | 6.2 | 0.87 | 30^{a} |
| 85 | 64 (43) | 31051 (43) | 14 | 0.68 | NM |
| 86 | 65 (47) | 31051 (47) | 6 | 0.48 | 30 |
| 87 | 65 (44) | 31051 (44) | 12 | 0.54 | 32 |
| 88 | 65 (26.7) | 31051 (62.2) | 11.1 | 2.04 | 27^{a} |
| 89 | 65 (70) | 31051 (30) | 0 | 0.51 | 29 |
| 90 | 66 (26.5) | 31051 (61.9) | 11.6 | 1.48 | 27^{a} |
| 91 | 66 (70) | 31051 (30) | 0 | 0.47 | 24 |
| 92 | 67 (47) | 31051 (47) | 6 | 0.65 | 30 |
| 93 | 68 (47) | 31051 (47) | 6 | 0.71 | 26 |

*Typical conditions for Samples 71-93: Promote blend with 0.2 pph 12% Cobalt Octoate, 0.1 pph DMA, and 50 ppm MTBHQ. Initiate with 1.25 pph MEKP 46-709 and pour into shrink bar. After 2 hours at 25° C., post-cure 1 hour at 60° C. and 2 hours at 120° C. Cool overnight and measure linear shrinkage and Barcol.
^{a}Measured prior to post-curing 2 hrs after initiation.

Shrink measurements of resin 31051-00 and Sample 1 from Table 1 was determined using ASTM test method D2566-79. The ratios between the unsaturated polyester resin and Sample 1 are listed in Table 10.

TABLE 10
Linear Shrinkage for Filled Blends Made From Copolystyrenes

| | | | Additional | | % Linear | |
|---|---|---|---|---|---|---|
| Sam- | Resin 1 | 31051 | Styrene | Filler Type | Shrink- | Average |
| ple | (pph) | pph | pph | (pph) | age* | Barcol* |
| 94 | 36 (29) | 29 | 8 | CaCO₃ (33) | 0.82 | 27 |
| 95 | 65 (29) | 29 | 8 | CaCO₃ (33) | 0.49 | 22 |
| 96 | 36 (29) | 29 | 8 | ATH (33) | 0.66 | 30 |
| 97 | 65 (29) | 29 | 8 | ATH (33) | 0.48 | 27 |

*Typical conditions for Samples 94-97: Promote blend with 0.2 pph 12% Cobalt Octoate, 0.1 pph DMA, and 50 ppm MTBHQ. Initiate with 1.25 pph MEKP 46-709 and pour into shrink bar. After 2 hours at 25° C., post-cure 1 hour at 60° C. and 2 hours at 120° C. Cool overnight and measure linear shrinkage and Barcol.

Thickening behavior was also tested with several resin mixtures containing polystyrene. The thickeners used were diisocyanate intermediates such as Isonate 143L and Polylite® 31100, and modified carbodiimide resin intermediate CIPP 1070. The results are summarized in Table 11.

TABLE 11
Thickening behavior of functional copolystyrenes with polymeric
isocyanates or isocyanurates

| Sample | Resin (pph) | Thickener (pph) | Snapback (min) |
|---|---|---|---|
| 98 | 103 (80) | Isonate 143L (20) | 17.5 |
| 99 | 103 (80) | 31100-00 (20) | 24.0 |
| 100 | 103 (90) | Isonate 143L (10) | 17.5 |
| 101 | 104 (80) | CIPP 1070 (20) | 67.0 |
| 102 | 104 (90) | CIPP 1070 (10) | 3000+ |

Resin 103 is similar to 39 except double the HydroxyTEMPO and BPO charge was used
Resin 104 is similar to 26 except half the HydroxyTEMPO and BPO charge was used

What is claimed:

1. A crosslinkable polymer system comprising
(a) a main portion comprising a product Q formed from an aromatic ethylenically unsaturated moiety and a first reactive ethylenically unsaturated moiety wherein product Q provides carbon-carbon linkages in the backbone of said crosslinkable polymer system and a second reactive ethylenically unsaturated moiety at least partially reacted with said first reactive ethylenically unsaturated moiety of product Q, and
(b) a first terminal moiety comprising a nitroxide containing group.

2. The crosslinkable polymer system according to claim 1, wherein the covalently bonded nitroxide free radical group is provided by a hindered nitroxide compound selected from the group consisting of compounds having the formula: 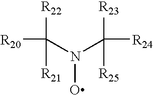
where R₂₀, R₂₁, and R₂₅ are identical or different and represent a hydrogen atom, a linear, branch or cyclic alkyl radical having a number of carbon atoms ranging from 1 to 30, an aryl radical, or an aralkyl radical having a number of carbon atoms ranging from 1 to 30, R₂₂ and R₂₃ are independently selected from the group consisting of C₁-C₂₀ alkyl, C₂-C₁₈ alkenyl, C₂-C₁₈ alkynyl, C₃-C₁₂ cycloalkyl, C₃-C₁₂ heterocycloalkyl, and C₆-C₂₄ aryl, optionally substituted by NO₂, halogen, amino, hydroxy, cyano, carboxy, ketone, C₁-C₄ alkoxy, C₁-C₄ alkylthio, C₁-C₄ alkylamino; or, R₂₂ and R₂₃ can be connected to one another to form a ring, a C₃-C₁₂ cycloalkyl radical, a (C₄-C₁₂ alkanol)yl radical or a C₂-C₁₃-heterocycloalkyl radical containing oxygen, phosphorus, sulfur or nitrogen atoms; or R₂₂ and R₂₃ together can form a residue of a polycyclic ring system or a polycyclic heterocycloliphatic ring system containing oxygen, phosphorus, sulfur or nitrogen atoms, optionally at least one of the radicals R₂₂ and R₂₃ contains a functionality that may derived from epoxy, silyl, siloxane, acetoacetoxy, cyano, halogen, tertiary amines, an active hydrogen containing component hydroxyl, primary or secondary amino, amide, phenol, thiol, silanol, —P—OH, —P—H and combinations thereof; R₂₃ and R₂₅ can be connected to one another so that to form a ring which includes the carbon atom carrying the R₂₃ and R₂₅ radicals, the ring including the carbon carrying the R₂₃ and R₂₅ radicals, 3 to 8 carbon atoms; R₂₄ is independently selected from the group consisting of halogen, cyano, COOR₂₀, —S—COR₂₀, —OCOR₂₀, amido, —S—C₆H₅, carbonyl, alkenyl, and alkyl of 1 to 15 carbon atoms, or may be part of a cyclic structure which may be fused with it another saturated or aromatic ring; —P(U)R₁₈R₁₉, where R₁₈ and R₁₉ are identical or different, represent a linear or branch alkyl having a number of carbon atoms ranging from 1 to 20 or a cycloalkyl, aryl, alkoxyl, aryloxyl, aralkyloxyl, perfluoroalkyl, aralkyl, dialkyl or diarylamino, alkylarylamino or thioalkyl radical, or R₁₈ and R₁₉ are connected to one another so as to form a ring which includes the phosphorus atom, the heterocycle having a number of carbon atoms ranging from 2 to 4 and being able in addition to comprise of one or more oxygen, sulfure or nitrogen atoms, U represents an oxygen, sulfur or selenium atom, and U is equal to zero or 1;
and the formula: 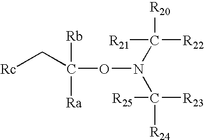
wherein R₂₀, R₂₁, R₂₂, R₂₃, R₂₄ and R₂₅ are as defined above; Rₐ, R_{b} and R_{c} may be represented by H, halogen, CN, straight or branched alkyl of from 1 to 40 carbon atoms, a COOR₉, where R₉ is H, an alkyl metal, or a C₁-C₄₀alkyl group; an epoxy moiety having 1 to 4 epoxy groups; R_{b} and R_{c} are independently selected from the group consisting of halogen, cyano, COOR₂₀, —S—COR₂₀, —OCOR₂₀, amido, —S—C₆H₅, carbonyl, alkenyl, and alkyl of 1 to 15 carbon atoms, or may be part of a cyclic structure which may be fused with it another saturated or aromatic ring; and Rₐ is a straight or branched alkyl of from 1 to 40 carbon atoms containing reactive functional groups.

3. The crosslinkable polymer system according to claim 2 further including a second terminal moiety provided by a peroxide or azo group selected from the group consisting of diacyl peroxides, peroxydicarbonates, peroxyesters, dialkylperoxides, ketone peroxides, hydroperoxides, peroxyketals and azo type initiators, or provided by a radiation curing type initiator.

4. The crosslinkable polymer system according to claim 1, wherein the first reactive ethylenically unsaturated monomer has the formula 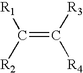
wherein R₁, R₂, R₃ and R₄ are independently selected from the group consisting of H, halogen, CN, straight or branched alkyl having 1 to 20 carbon atoms, halogen-substituted straight or branched alkyl having 1 to 20 carbon atoms, α, β-unsubstituted straight or branched alkenyl having 2 to 10 carbon atoms, -straight or branched alkenyl having 2 to 10 carbon atoms, unsubstituted straight or branched alkynyl having 2 to 10 carbon atoms, C₃ to C₈ cycloalkyl, amines, substituted phosphorus, sylyl, siloxy, epoxy, isocyanate, and hydroxyl, C(═Y)R₅, C(═Y)NR₆R₇, YC(═Y)R₅, SOR₅, SO₂R₅, OSO₂R₅, NR₈SO₂R₅, PR₅², P(═Y)R₅², YPR₅², YP(═Y)R₅², NR₈², which can be quaternized with an additional R₈, aryl, or heterocyclyl group, where Y may be NR₈, S or O, R₅ is alkyl of from 1 to 20 carbon atoms, an alkylthio group with 1 to 20 carbon atoms, OR₁₅ where R₁₅ is hydrogen or an alkyl metal, alkoxy of from 1 to 20 carbon atoms, aryloxy or heterocyclyloxy; R₆ and R₇ are independently H or alkyl of from 1 to 20 carbon atoms, or R₆ and R₇ may be joined together to form an alkylene group of from 2 to 7 carbon atoms where they form a 3- to 8-member ring, and R₈ is H, straight or branched C₁-C₂₀ alkyl or aryl; and R₃ and R₄ are independently selected from the group consisting of H, halogen, C₁-C₆ alkyl and COOR₉, where R₉ is H, an alkyl metal, or a C₁-C₄₀ alkyl group; or R₁ and R₃ can together form a group of the formula (CH₂)ₙ; which can be substituted with 1 to 2n halogen atoms or a group of the formula C(═O)—Y—C(═O), where n is from 2 to 6, and Y is defined as before; and where at least two of R₁, R₂, R₃ and R₄ are H or a methyl group.

5. The crosslinkable polymer system according to claim 1, wherein the second reactive ethylenically unsaturated moiety is selected from the group consisting of (meth)acrylates, polyfunctional acrylates, vinyl aromatics, vinyl heterocyclyl, vinyl halides, vinyl esters of carboxylic acids, and methyl(allylic) monomers.

6. The crosslinkable polymer system of claim 1, further comprising one or more additives selected from the group consisting of antioxidants, solvents, polymerization inhibitors, chain transfer agents, polymerization accelerators, and UV stabilizers.

7. The crosslinkable polymer system according to claim 1, further comprising a thermosetable moiety, a thermoplastic moiety or monomer wherein said thermosetable moiety, thermoplastic moiety or monomer is crosslinkable with said first or second reactive ethylenically unsaturated moiety or both.

8. The crosslinkable polymer system according to claim 3, further comprising a thermosetable moiety, a thermoplastic moiety or monomer wherein said thermosetable moiety, thermoplastic moiety or monomer is crosslinkable with said first or second reactive ethylenically unsaturated moiety or both.

9. A polymer comprising the cured crosslinkable polymer system of claim 1.

10. The polymer according to claim 9 further including an additive selected from the group consisting of fiber reinforcements, fillers, thickening agents, flow agents, lubricants, air release agents, wetting agents, UV stabilizers, compatibilizers, shrink reducing agents, waxes, and mold release agents.

11. A crosslinkable polymer system comprising
(a) a main portion comprising a product Q formed from an aromatic ethylenically unsaturated moiety and a reactive ethylenically unsaturated moiety, said product Q providing carbon-carbon linkages in the backbone of said crosslinkable system, and a thermosetable moiety, a thermoplastic moiety or a monomer wherein said product Q and said thermosetable moiety, thermoplastic moiety or monomer is crosslinkable with said reactive moiety of product Q; and
(b) a first terminal moiety comprising a nitroxide containing group.

12. The crosslinkable polymer system according to claim 11, wherein the covalently bonded nitroxide free radical group is provided by a hindered nitroxide compound selected from the group consisting of compounds having the formula: 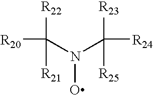
where R₂₀, R₂₁, and R₂₅ are identical or different and represent a hydrogen atom, a linear, branch or cyclic alkyl radical having a number of carbon atoms ranging from 1 to 30, an aryl radical, or an aralkyl radical having a number of carbon atoms ranging from 1 to 30, R₂₂ and R₂₃ are independently selected from the group consisting of C₁-C₂₀ alkyl, C₂-C₁₈ alkenyl, C₂-C₁₈ alkynyl, C₃-C₁₂ cycloalkyl, C₃-C₁₂ heterocycloalkyl, and C₆-C₂₄ aryl, optionally substituted by NO₂, halogen, amino, hydroxy, cyano, carboxy, ketone, C₁-C₄ alkoxy, C₁-C₄ alkylthio, C₁-C₄ alkylamino; or, R₂₂ and R₂₃ can be connected to one another to form a ring, a C₃-C₁₂ cycloalkyl radical, a (C₄-C₁₂ alkanol)yl radical or a C₂-C₁₃-heterocycloalkyl radical containing oxygen, phosphorus, sulfur or nitrogen atoms; or R₂₂ and R₂₃ together can form a residue of a polycyclic ring system or a polycyclic heterocycloliphatic ring system containing oxygen, phosphorus, sulfur or nitrogen atoms, optionally at least one of the radicals R₂₂ and R₂₃ contains a functionality that may derived from epoxy, silyl, siloxane, acetoacetoxy, cyano, halogen, tertiary amines, an active hydrogen containing component hydroxyl, primary or secondary amino, amide, phenol, thiol, silanol, —P—OH, —P—H and combinations thereof; R₂₃ and R₂₅ can be connected to one another so that to form a ring which includes the carbon atom carrying the R₂₃ and R₂₅ radicals, the ring including the carbon carrying the R₂₃ and R₂₅ radicals, 3 to 8 carbon atoms; R₂₄ is independently selected from the group consisting of halogen, cyano, COOR₂₀, —S—COR₂₀, —OCOR₂₀, amido, —S—C₆H₅, carbonyl, alkenyl, and alkyl of 1 to 15 carbon atoms, or may be part of a cyclic structure which may be fused with it another saturated or aromatic ring; —P(U)R₁₈R₁₉, where R₁₈ and R₁₉ are identical or different, represent a linear or branch alkyl having a number of carbon atoms ranging from 1 to 20 or a cycloalkyl, aryl, alkoxyl, aryloxyl, aralkyloxyl, perfluoroalkyl, aralkyl, dialkyl or diarylamino, alkylarylamino or thioalkyl radical, or R₁₈ and R₁₉ are connected to one another so as to form a ring which includes the phosphorus atom, the heterocycle having a number of carbon atoms ranging from 2 to 4 and being able in addition to comprise of one or more oxygen, sulfure or nitrogen atoms, U represents an oxygen, sulfur or selenium atom, and U is equal to zero or 1;
and the formula: 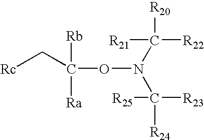
wherein R₂₀, R₂₁, R₂₂, R₂₃, R₂₄ and R₂₅ are as defined above; Rₐ, R_{b} and R_{c} may be represented by H, halogen, CN, straight or branched alkyl of from 1 to 40 carbon atoms, a COOR₉, where R₉ is H, an alkyl metal, or a C₁-C₄₀ alkyl group; an epoxy moiety having 1 to 4 epoxy groups; R_{b} and R_{c} are independently selected from the group consisting of halogen, cyano, COOR₂₀, —S—COR₂₀, —OCOR₂₀, amido, —S—C₆H₅, carbonyl, alkenyl, and alkyl of 1 to 15 carbon atoms, or may be part of a cyclic structure which may be fused with it another saturated or aromatic ring; and Rₐ is a straight or branched alkyl of from 1 to 40 carbon atoms containing reactive functional groups.

13. The crosslinkable polymer system according to claim 12 further including a second terminal moiety provided by a peroxide or azo group selected from the group consisting of diacyl peroxides, peroxydicarbonates, peroxyesters, dialkylperoxides, ketone peroxides, hydroperoxides, peroxyketals, and azo type initiators, or provided by a radiation curing type initiator.

14. The crosslinkable polymer system according to claim 12, wherein the first reactive ethylenically unsaturated monomer has the formula 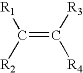
wherein R₁, R₂, R₃ and R₄ are independently selected from the group consisting of H, halogen, CN, straight or branched alkyl having 1 to 20 carbon atoms, halogen-substituted straight or branched alkyl having 1 to 20 carbon atoms, α, β-unsubstituted straight or branched alkenyl having 2 to 10 carbon atoms, -straight or branched alkenyl having 2 to 10 carbon atoms, unsubstituted straight or branched alkynyl having 2 to 10 carbon atoms, C₃ to C₈ cycloalkyl, amines, substituted phosphorus, sylyl, siloxy, epoxy, isocyanate, and hydroxyl, C(═Y)R₅, C(═Y)NR₆R₇, YC(═Y)R₅, SOR₅, SO₂R₅, OSO₂R₅, NR₈SO₂R₅, PR₅, P(═Y)R₅², YPR₅², YP(═Y)R₅², NR₈², which can be quaternized with an additional R₈, aryl, or heterocyclyl group, where Y may be NR₈, S or O, R₅ is alkyl of from 1 to 20 carbon atoms, an alkylthio group with 1 to 20 carbon atoms, OR₁₅ where R₁₅ is hydrogen or an alkyl metal, alkoxy of from 1 to 20 carbon atoms, aryloxy or heterocyclyloxy; R₆ and R₇ are independently H or alkyl of from 1 to 20 carbon atoms, or R₆ and R₇ may be joined together to form an alkylene group of from 2 to 7 carbon atoms where they form a 3- to 8-member ring, and R₈ is H, straight or branched C₁-C₂₀ alkyl or aryl; and R₃ and R₄ are independently selected from the group consisting of H, halogen, C₁-C₆ alkyl and COOR₉, where R₉ is H, an alkyl metal, or a C₁-C₄₀ alkyl group; or R₁ and R₃ can together form a group of the formula (CH₂)ₙ; which can be substituted with 1 to 2n halogen atoms or a group of the formula C(═O)—Y—C(═O), where n is from 2 to 6, and Y is defined as before; and where at least two of R₁, R₂, R₃ and R₄ are H or a methyl group.

15. The crosslinkable polymer system according to claim 12, wherein the second reactive ethylenically unsaturated moiety is selected from the group consisting of (meth)acrylates, polyfunctional acrylates, vinyl aromatics, vinyl heterocyclyl, vinyl halides, vinyl esters of carboxylic acids, and methyl(allylic) monomers.

16. The crosslinkable polymer system of claim 12, further comprising one or more additives selected from the group consisting of antioxidants, solvents, polymerization inhibitors, chain transfer agents, polymerization accelerators, and UV stabilizers.

17. A polymer comprising the cured crosslinkable polymer system of claim 12.

18. The polymer according to claim 17 further including an additive selected from the group consisting of fiber reinforcements, fillers, thickening agents, flow agents, lubricants, air release agents, wetting agents, UV stabilizers, compatibilizers, shrink reducing agents waxes, and mold release agents.

19. A crosslinkable polymer having the formula: 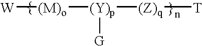
wherein W is a moiety of a radical polymerization catalyst, a residue of an ethylenically unsaturated monomer prereacted with a nitroxide initiator, or a residue of an alkyl or aryl compound prereacted with a nitroxide monomer; M is a moiety that is free of reactive functional groups, of at least one ethylenically unsaturated radically polymerizable monomer; Y is a moiety, that has a reactive functional group, of at least one ethylenically unsaturated monomer; G is a vinyl unsaturated monomer that is capable of reacting with the reactive functional groups of Y and G can be a straight or branched alkyl, aryl, aryloxy of from 1 to 40 carbon atoms, aliphatic or aromatic polymeric intermediates with molecular weights of up to 50,000 containing functional groups selected from the group consisting of epoxy, silyl, siloxane, acetoacetoxy, anhydride, isocyanato, cyano, halogen, tertiary amines, quaternary ammonium or phosphonium salts or an active hydrogen containing component amide, phenol, thiol, silanol, —P—OH, —P—H and combinations thereof; Z is a moiety, that is free of reactive functional groups, of at least one ethylenically unsaturated radical polymerizable monomer containing aliphatic and/or aromatic groups and may contain a straight or branched alkyl, aryl, aryloxy of from 1 to 40 carbon atoms, aliphatic or aromatic polymeric intermediates with molecular weights of up to 50,000; T represents a covalently bonded nitroxide free radical group; o is a number from 1 to 90; p is a number from 1 to 50; q is a number from 0 to 30; and o, p, q, and n are each independently selected for each structure such that the polymer, copolymer or oligomer has a weight average molecular weight (Mw) of at least 400 to 80,000 g/mol.

20. A method of making a crosslinkable polymer system comprising the steps of:
(a) forming a main portion reaction mixture comprising an aromatic ethylenically unsaturated moiety and a first reactive ethylenically unsaturated moiety;
(b) adding a nitroxide containing group to the main portion reaction mixture to provide a first terminal moiety on the main portion reaction mixture; and
(c) polymerizing the product of (a) and (b).

21. The method according to claim 20, further comprising reacting a second reactive ethylenically unsaturated monomer with the polymerized product of step (c).

22. The method according to claim 21, further comprising reacting a thermosetable moiety, a thermoplastic moiety or a monomer crosslinkable with the first and/or second reactive ethylenically unsaturated monomer of the polymerized product of step (c).

23. The method according to claim 21, wherein the step (c) of polymerizing includes heating to a temperature of about 10° to 200° C. at a pressure of 0.10 MPa to 30 MPa.

24. The method according to claim 21, wherein the step of (c) polymerizing includes subjecting (a) and (b) to electromagnetic radiation.

25. A polymer, copolymer or oligomers in linear, block copolymer, graft, comb-like, star-like or hyperbranched form prepared by the method of claim 21.

26. A method of making a crosslinked polymer comprising:
(a) forming a main portion reaction mixture comprising an aromatic ethylenically unsaturated moiety and a first reactive ethylenically unsaturated moiety;
(b) adding a nitroxide containing group to the main portion reaction mixture to provide a first terminal moiety on the main portion reaction mixture;
(c) polymerizing the product of (a) and (b); and
(d) curing the polymerized product of step (c) to provide a crosslinked polymer.

27. The method according to claim 26, further comprising reacting a second reactive ethylenically unsaturated monomer with the polymerized product of step (c).

28. The method according to claim 26, further comprising reacting a thermosetable moiety, a thermoplastic moiety or a monomer crosslinkable with the first and/or second reactive ethylenically unsaturated monomer of the polymerized product of step (c).
